(19) United States
(12) Patent Application Publication
(10) Pub. No.: US 2012/0327882 A1
(43) Pub. Date: Dec. 27, 2012

(54) BASE STATION, MOBILE STATION, MIMO FEEDBACK RECEIVING METHOD, AND MIMO FEEDBACK TRANSMITTING METHOD

(75) Inventors: Jisoo Park, Daejeon (KR); Namsuk Lee, Daejeon (KR); Sook Jin Lee, Daejeon (KR); Youn Ok Park, Daejeon (KR); Dong Seung Kwon, Daejeon (KR)

(73) Assignee: Electronics Telecommunications Research Institute, Daejeon (KR)

(21) Appl. No.: 13/582,702

(22) PCT Filed: Mar. 4, 2011
(86) PCT No.: PCT/KR2011/001531

§ 371 Date: Sep. 4, 2012

(30) Foreign Application Priority Data
Mar. 4, 2010 (KR) 10-2010-0019603
Mar. 5, 2010 (KR) 10-2010-0020094
Mar. 8, 2010 (KR) 10-2010-0020360
Mar. 11, 2010 (KR) 10-2010-0021966
Mar. 4, 2011 (KR) 10-2011-0019656

(51) Int. Cl. H04W 72/04

(52) U.S. Cl. 370/329

(57) ABSTRACT

A mobile station receives a MIMO feedback mode bitmap and information on a MIMO feedback period. The mobile station estimates channel information corresponding to at least one MIMO feedback mode indicated by the MIMO feedback mode bitmap. The mobile station generates a MIMO feedback including the MIMO feedback mode bitmap and the channel information corresponding to the at least one MIMO feedback mode indicated by the MIMO feedback mode bitmap. The mobile station transmits the MIMO feedback at the advent of the MIMO feedback period.

### TECHNICAL FIELD

The present invention relates a base station and a mobile station. In particularly, the present invention relates a method for receiving a multi-input multi-output (MIMO) feedback and a method for transmitting the MIMO feedback.

### BACKGROUND ART

A wideband wireless access system supports a hybrid automatic repeat request (HARQ) for high-speed data packet transmission, low delay and communication reliability as a next generation wireless communication scheme. The wideband wireless access system adopts the MIMO technology for improving data transmission/reception efficiency using multiple transmission antennas and multiple reception antennas.

According to the HARQ scheme, a receiver decodes a data packet received by a physical layer and checks detection of errors. If no error occurs, the receiver transmits an acknowledgement (ACK) signal as a response signal to inform success of receiving the data packet to a transmitter. However, if the error occurs after the receiver decodes the data packet, the receiver transmits a negative acknowledgement (NACK) signal as a response signal to inform detection of the error to the transmitter. If the transmitter receives an NACK signal, the transmitter can retransmits the data packets.

The retransmission scheme of the HARQ may be classified into a synchronous HARQ scheme and an asynchronous HARQ scheme depending on the transmission timing of a retransmission packet. In the synchronous HARQ scheme, the transmission timing of a retransmission packet for an initial transmission packet is kept constant. In the asynchronous HARQ scheme, a scheduler of a base station determines the transmission timing of a retransmission packet for an initial transmission packet.

The HARQ may be classified into an adaptive HARQ and a non-adaptive HARQ according to whether the amount and positions of allocated resources are varied. The adaptive HARQ is a scheme in which the amount and positions of allocated resources are varied. The non-adaptive HARQ is a scheme in which the amount and positions of allocated resources are fixed.

By properly combining the synchronous and asynchronous HARQ schemes and the adaptive and non-adaptive HARQ schemes together, and employing low signaling overhead, a high scheduling gain and a high-speed data transmission effect are achieved. For example, a mobile communication system may adopt an adaptive asynchronous HARQ for downlink (DL) data transmission and the synchronous HARQ for uplink (UL) data transmission.

In the wireless communication method, a base station generally schedules radio resources used for transmitting data for uplink and downlink. A terminal can transmit, to the base station through the uplink, feedback information including channel information such as various channel state information (CSI) and a channel quality indicator (CQI) required for applying the MIMO scheme. The base station can schedule radio resources and transmit/receive data by using the feedback information which is received from a mobile station.

According to the MIMO technology, the base station and the mobile station use multiple antennas, respectively, so that frequency efficiency and wireless link capacity can be greatly improved. So the MIMO is getting more important as the major technology of wireless communication method requiring high-speed data transmission.

The MIMO technology may be classified into a spatial multiplexing (SM) scheme and a spatial transmit diversity scheme. According to the spatial multiplexing scheme, different data are transmitted in multiple transmission antennas at the same time so that high-speed data transmission can be performed even though the system bandwidth is not expanded. According to the spatial transmit diversity scheme, the same data are transmitted in multiple transmission antennas at the same time so that the diversity can be obtained and data reliability can be improved.

In the other hand, the MIMO technology may be classified into a closed loop MIMO (CL MIMO) scheme and an open loop MIMO (OL MIMO) scheme.

The closed loop MIMO scheme is a technology that a base station uses various kinds of channel information included in feedback information received from a mobile station when the base station transmits a data to the mobile station. According to the closed loop MIMO scheme, the mobile station estimates channel information for each channel through a plurality of antennas and transmits feedback information including various kinds of estimated channel information to the base station. The base station applies received feedback information to the transmission data in order to obtain more precise MIMO technology effect. Through this, the reliable high-speed data transmission effect can be obtained.

The open loop MIMO scheme is a technology a base station does not use channel information received from a mobile station when the base station transmits a data to the mobile station. In the open loop MIMO scheme, the feedback information does not have to be transmitted. Even if the feedback information is transmitted, it is possible for the base station not to use the channel information included in this feedback information.

Generally, in the communication system, the open loop MIMO scheme can be applied to the channel environment for mobile stations with high-speed mobility, and the closed MIMO scheme can be applied to the channel environment for mobile stations with low-speed mobility. Because the channel characteristics rapidly change in the channel environment for mobile stations with high-speed mobility, it is difficult to rely on channel information, so the open loop MIMO scheme is applied. Because the channel characteristics slowly change in the channel environment for mobile stations with low-speed mobility, it is possible to rely on channel information and communication devices are less sensitive to delay, so the closed loop MIMO scheme can be applied.

The MIMO transmission mode can be classified to open loop single user MIMO (OL SU MIMO), closed loop single user MIMO (CL SU MIMO), open loop multiple user MIMO (OL MU MIMO), closed loop multiple user MIMO (CL MU MIMO), etc. The MIMO transmission mode which further adopts the spatial multiplexing (SM) scheme and the spatial transmission diversity scheme can be applied to uplink and downlink. The MIMO transmission mode where the open loop collaborative spatial multiplexing scheme is applied to MU MIMO can be used as necessary in uplink.

In order to support various MIMO transmission modes in downlink, one or more MIMO feedback modes where the mobile station transmits different channel information such as channel state information (CSI) or channel quality indicator (CQI) can be supported. In order to effectively support various MIMO transmission modes, the base station can request various kinds of channel information according to various MIMO transmission modes to the mobile station through one MIMO feedback mode or plural MIMO feedback modes. That is, in a case that the base station requests feedback information to the mobile station, the base station can indicate the feedback mode for different channel information to request only necessary channel state information, or can indicate a plurality of feedback modes for different channel information to request channel state information necessary for MIMO system. At this time, the mobile station composes various kinds of channel information according to various kinds of feedback modes allocated by the base station to send them to the base station.

The base station can request information for several channels to the mobile station periodically or irregularly, respectively. A short period or a long period can be allocated as the MIMO feedback period.

In a case that the base station requests plural pieces of feedback information to the mobile station, the mobile station can transmit the plural pieces of feedback information through plural messages, respectively. However, this can cause waste of radio resources due to ineffective use of the radio resources.

Furthermore, when the base station requires the feedback information to the mobile station in the short period and the long period, the radio resources can be wasted. That is, according to the HARQ process, the base station decodes a data packet of the received feedback information message. When detecting an error, the base station transmits a negative acknowledgement (NACK) signal to the mobile station as a response signal to notify the mobile station of the error detection. The mobile station retransmits the previous feedback information message when receiving the NACK signal. If the mobile station succeeds to receive data of a next feedback information message prior to the previous feedback information message, the radio resources can be wasted by the retransmission of the previous feedback information message.

Accordingly, a method for efficiently managing the radio resources is required. The method should reduce a usage of radio resources by transmitting a plurality of single feedback information according to a feedback mode and its characteristic through messages having less number than the plurality of single feedback information, and should control a retransmission process of the feedback information message according to the HARQ process.

### DISCLOSURE

### Technical Problem

An aspect of the present invention provides a MIMO feedback receiving method and a MIMO feedback transmitting method for reducing waste of radio resources.

### Technical Solution

According to an embodiment of the present invention, a method of transmitting a MIMO feedback is provided by a mobile station. The method includes receiving a MIMO feedback mode bitmap, estimating channel information corresponding to at least one MIMO feedback mode indicated by the MIMO feedback mode bitmap, generating a MIMO feedback including the MIMO feedback mode bitmap and the channel information corresponding to the at least one MIMO feedback mode indicated by the MIMO feedback mode bitmap, and transmitting the MIMO feedback to the base station.

The MIMO feedback mode bitmap may include one or more bits representing one or more MIMO feedback modes for reporting wideband channel quality information, respectively, and one or more bits representing one or more MIMO feedback modes for reporting subband channel quality information, respectively.

The method may further include receiving information on a MIMO feedback period, and the MIMO feedback may be transmitted at advent of the MIMO feedback period.

The method may further include receiving information on a hybrid automatic repeat request (HARQ) channel identifier for the MIMO feedback, and receiving information on a radio resource allocated to the HARQ channel identifier. The MIMO feedback may be transmitted through the radio resource allocated to the HARQ channel identifier.

According to another embodiment of the present invention, a method of receiving a MIMO feedback is provided by a base station. The method includes transmitting a MIMO feedback request including a MIMO feedback mode bitmap to the mobile station, and receiving, from the mobile station, a MIMO feedback including the MIMO feedback mode bitmap and channel information corresponding to at least one MIMO feedback mode indicated by the MIMO feedback mode bitmap, in response to the MIMO feedback request.

The MIMO feedback mode bitmap may include one or more bits representing one or more MIMO feedback modes for reporting wideband channel quality information, respectively, and one or more bits representing one or more MIMO feedback modes for reporting subband channel quality information, respectively.

The method may further include transmitting information on an HARQ channel identifier for the MIMO feedback to the mobile station, and transmitting information on a radio resource allocated to the HARQ channel identifier to the mobile station. The MIMO feedback request may include information on a MIMO feedback period, and the MIMO feedback may be received through the radio resource allocated to the HARQ channel identifier at advent of the MIMO feedback period.

According to yet another embodiment of the present invention, a method of transmitting a MIMO feedback is provided by a mobile station. The method includes receiving a MIMO feedback request including information on a MIMO feedback period, estimating channel information for MIMO, generating a signaling header including estimated channel information, and transmitting the signaling header to the base station at advent of the MIMO feedback period standalone or together with a MAC protocol data unit.

The MIMO feedback request may include a first MIMO feedback mode bitmap, and estimating the channel information may include estimating channel information corresponding to at least one MIMO feedback mode indicated by the first MIMO feedback mode bitmap.

The channel information may correspond to channel quality information.

The signaling header may further include a second MIMO feedback mode bitmap representing the at least one MIMO feedback mode.

The channel information may correspond to a transmit correlation matrix.

According to yet another embodiment of the present invention, a method of receiving a MIMO feedback is provided by a base station. The method includes transmitting a MIMO feedback request including information on a MIMO feedback period to a mobile station, and receiving, standalone or together with a MAC protocol data unit, a signaling header including channel information for MIMO from the mobile station at advent of the MIMO feedback period, in response to the MIMO feedback request.

The MIMO feedback request may include a first MIMO feedback mode bitmap, the channel information may correspond to information corresponding to at least one MIMO feedback mode indicated by the first MIMO feedback mode bitmap, and the signaling header may further include a second MIMO feedback mode bitmap representing the at least one MIMO feedback mode.

The channel information may correspond to channel quality information.

The method channel information may correspond to a transmit correlation matrix.

According to yet another embodiment of the present invention, a method of transmitting a MIMO feedback is provided by a mobile station. The method includes receiving a MIMO feedback request including a first MIMO feedback mode bitmap, estimating channel information corresponding to at least one MIMO feedback mode indicated by the first MIMO feedback mode bitmap, generating a MIMO feedback header including a second MIMO feedback mode bitmap representing the at least one MIMO feedback mode and channel information corresponding to the at least one MIMO feedback mode, and transmitting the MIMO feedback header to a base station.

The second MIMO feedback mode bitmap may include one or more bits representing one or more MIMO feedback modes for reporting wideband channel quality information, respectively.

The second MIMO feedback mode bitmap may further include one or more bits representing one or more MIMO feedback modes for reporting subband channel quality information, respectively.

The MIMO feedback request may further include information a MIMO feedback period, and the MIMO feedback header may be transmitted at advent of the MIMO feedback period.

According to yet another embodiment of the present invention, a method of receiving a MIMO feedback is provided by a base station. The method includes transmitting a MIMO feedback request including a first MIMO feedback mode bitmap to a mobile station, and receiving, from the mobile station, a MIMO feedback header including channel information corresponding to the at least one MIMO feedback mode indicated by the first MIMO feedback mode bitmap and a second MIMO feedback mode bitmap representing the at least one MIMO feedback mode, in response to the MIMO feedback request.

The second MIMO feedback mode bitmap may include one or more bits representing one or more MIMO feedback modes for reporting wideband channel quality information, respectively.

The second MIMO feedback mode bitmap may further include one or more bits representing one or more MIMO feedback modes for reporting subband channel quality information, respectively.

According to yet another embodiment of the present invention, a method of receiving a MIMO feedback is provided by a base station. The method includes receiving a first MIMO feedback with a first channel identifier through a first radio resource from a mobile station, transmitting, to the mobile station, resource allocation information for allocating a second radio resource to the first channel identifier in a case of failing to decode the first MIMO feedback wherein a location of the second radio resource is different from a location of the first radio resource, and re-receiving the first MIMO feedback from the mobile station through the second radio resource.

The method may further include receiving a second MIMO feedback with a second channel identifier from the mobile station through the first radio resource, and finishing re-receiving the first MIMO feedback when succeeding in decoding the second MIMO feedback before the first MIMO feedback.

The second channel identifier may correspond to a next identifier of the first channel identifier among a plurality of channel identifiers.

The first MIMO feedback may be received in a first period, the second MIMO feedback may be received in a second period, and the first period may be shorter than the second period.

The first MIMO feedback may be received in a first period, the second MIMO feedback may be received in a second period, and the first period may be longer than the second period.

According to yet another embodiment of the present invention, a method of transmitting a MIMO feedback is provided by a mobile station. The method includes transmitting a first MIMO feedback with first channel identifier to a base station through a first radio resource, receiving, together with a negative reception acknowledgement response for the first MIMO feedback from the base station, resource allocation information for allocating a second radio resource to the first channel identifier, wherein a location of the second radio resource is different from a location of the first radio resource, and retransmitting the first MIMO feedback to the base station through the second radio resource.

The method may further include transmitting a second MIMO feedback with a second channel identifier to the base station through the first radio resource, and finishing retransmitting the first MIMO feedback when receiving a positive acknowledgement for the second MIMO feedback before a positive acknowledgement for the first MIMO feedback.

The method may further include determining the second channel identifier as a next identifier of the first channel identifier among a plurality of channel identifiers.

### Advantageous Effects

According to an aspect of the present invention, a MIMO feedback can efficiently transmitted by reducing waste of radio resources.

### DESCRIPTION OF DRAWINGS

FIG. 1 shows a transmission method of MIMO feedback information according to an embodiment of the present invention.

FIG. 2 shows a retransmission method of MIMO feedback information according to an embodiment of the present invention.

FIG. 3 shows a retransmission method of MIMO feedback information according to an embodiment of the present invention.

FIG. 4 shows a retransmission method of MIMO feedback information according to an embodiment of the present invention.

FIG. 5 shows retransmission method of MIMO feedback information according to an embodiment of the present invention.

FIG. 6 shows retransmission method of MIMO feedback information according to an embodiment of the present invention.

FIG. 7 shows retransmission method of MIMO feedback information according to an embodiment of the present invention.

FIG. 8 shows retransmission method of MIMO feedback information according to an embodiment of the present invention.

FIG. 9 is a block diagram of a base station according to an embodiment of the present invention.

FIG. 10 is a block diagram of a mobile station according to an embodiment of the present invention.

### MODE FOR INVENTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

In this specification, a mobile station (MS) may designate a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In this specification, a base station (BS) may designate an access point (AP), a radio access station (RAS), a Node B, a base transceiver station (BTS), a mobile multihop relay (MMR)-BS, etc., and may include the entire or partial functions of the access point, the radio access station, the node B, the base transceiver station, the MMR-BS, etc.

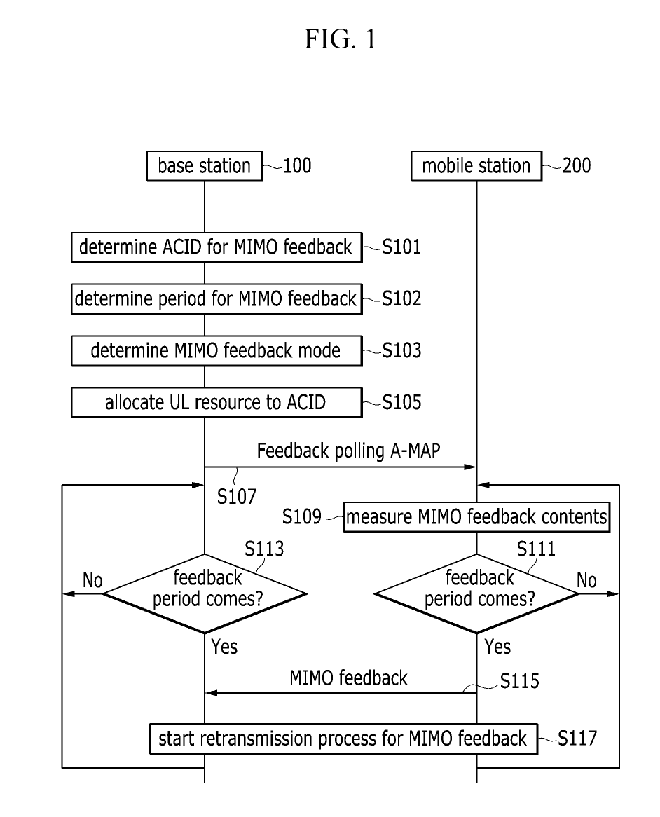

Next, a transmission method of MIMO feedback information according to an embodiment of the present invention will be described with reference to FIG. 1.

FIG. 1 shows a transmission method of MIMO feedback information according to an embodiment of the present invention.

First, a base station 100 determines HARQ channel identifier (ACID) for MIMO feedback of a mobile station 200 in step S101.

Next, the base station 100 determines one or more periods for MIMO feedback of the mobile station 200 in step S102.

Further, the base station 100 determines one or more MIMO feedback modes of the mobile station 200 in step S103.

The base station 100 allocates an uplink resource to the ACID for the MIMO feedback of the mobile station 200 in step S105.

The base station 100 transmits one or more feedback polling A-MAP messages to a mobile station 200 to notify the ACID for MIMO feedback, the location and the size of the uplink resource allocated to the ACID, the one or more periods for MIMO feedback, and the one or more MIMO feedback modes in step S107. The feedback polling A-MAP may be used by the base station 100 to schedule MIMO feedback transmission.

Table 1 shows the feedback polling A-MAP according to an embodiment of the present invention.

TABLE 1

| | Size | |
|---|---|---|
| Syntax | (bits) | Notes |
| Feedback_Polling_A-MAP_IE( ){ | | |
| ... | | |
| Polling_sub_type | 1 | 0b0: uplink resource |
| | | allocation or de-allocation |
| | | 0b1: feedback mode |
| | | allocation or de-allocation |
| if(Polling_sub_type == 0b0){ | | |
| ... | | |
| Resource Index | 11 | Resource index includes |
| | | location and allocation size. |
| ... | | |
| ACID | 4 | HARQ channel identifier |
| MFM_allocation_index | 2 | |
| ... | | |
| Period | 4 | |
| } else { | | |
| ... | | |
| MFM_bitmap | 8 | |
| Period | 4 | |
| ... | | |
| } | | |

In Table 1, Polling_sub_type bit set to ‘0b0’ indicates uplink resource allocation or de-allocation, and Polling_sub_type bit set to ‘0b1’ indicates feedback mode allocation type. If Polling_sub_type bit is set to ‘0b0’, a dedicated UL allocation is included in this feedback polling A-MAP information element (IE). The dedicated UL allocation may be used by the mobile station 200 to transmit a feedback at the designated feedback transmission frame defined by this IE. If Polling_sub_type bit is set to ‘0b1’, no dedicated UL allocation is included. Instead, at the designated transmission frame defined by this IE, the mobile station 200 may configure the feedback, and the base station 100 may either include a UL allocation for the transmission using UL Basic Assignment A-MAP IE or UL Subband Assignment A-MAP IE, or the mobile station 200 may perform a transmission in a dedicated UL allocation assigned by a previous Feedback Polling A-MAP IE with feedback periods designating the same transmission frames.

The period field indicates an MIMO feedback transmission period as a short period and a long period. Resource for the MIMO feedback transmission is allocated at frames designated by every short and long period. The short period is p frames. The long period is q superframes. The first allocation starts two frames later. The frame index of the first allocation for the MIMO feedback transmission is given by i+2, where i is the index of the frame where the Feedback Polling A-MAP IE is transmitted.

The resource index field includes information on the location and size of the uplink allocated to the HARQ channel identifier corresponding to the ACID field.

The ACID field indicates a HARQ channel identifier. If q=0 or p=0, a single ACID is reserved. Otherwise, two ACIDs may be reserved.

The MFM_allocation_index field and the MFM_bitmap field indicate the MIMO feedback mode (MFM). The MIMO feedback mode may be classified as modes 0, 1, 2, 3, 4, 5, 6, and 7 according to a type of a resource unit and the MIMO transmission mode. In particular, MFM_allocation_index set to ‘0b00’ may indicate MFM 0 with Measurement Method Indication=0, MFM_allocation_index set to ‘0b01’ may indicate MFM 3 with all subbands, MFM_allocation_index set to ‘0b10’ may indicate MFM 6 with all subbands, and MFM_allocation_index set to ‘0b11’ may indicate that MFM is defined in Feedback Polling AMAP IE with Polling_sub-type=0b1. The MFM_bitmap field may indicate all MIMO feedback modes allocated by the base station 100 among all MIMO feedback modes supported by the wireless communication system. Table 2 shows all MIMO feedback modes supported by the wireless communication system.

TABLE 2

| MIMO | | |
|---|---|---|
| feedback | | |
| mode | description and type of RU | feedback content |
| 0 | OL SU MIMO SFBC/SM | 1. STC Rate |
| | (Diversity: DLRU, NLRU) | 2. Wideband CQI |
| | Sounding based CL SU | |
| | and MU MIMO | |
| 1 | OL SU MIMO CDR | 1. Wideband CQI |
| | (Diversity: NLRU) | |
| 2 | OL SU MIMO SM | 1. STC Rate |
| | (localized: SLRU) | 2. Subband CQI |
| | | 3. Subband Selection |
| 3 | CL SU MIMO | 1. STC Rate |
| | (localized: SLRU) | 2. Subband CQI |
| | | 3. Subband PMI |
| | | 4. Subband selection |
| | | 5. Wideband correlation matrix |
| 4 | CL SU MIMO | 1. STC Rate |
| | (Diversity: NLRU) | 2. Wideband CQI |
| | | 3. Wideband PMI |
| | | 4. Wideband correlation matrix |
| 5 | OL MU MIMO | 1. Subband CQI |
| | (localized: SLRU) | 2. Subband Selection |
| | | 3. MIMO stream indicator |
| 6 | CL MU MIMO | 1. Subband CQI |
| | (localized: SLRU) | 2. Subband PMI |
| | | 3. Subband Selection |
| | | 4. Wideband correlation matrix |
| 7 | CL MU MIMO | 1. Wideband CQI |
| | (Diversity: NLRU) | 2. Wideband PMI |
| | | 3. Wideband correlation matrix |

In Table 2, DLRU indicates the distributed logical resource unit, NLRU indicates the miniband logical resource unit, and SLRU indicates the subband logical resource unit.

MIMO feedback mode 0 is used for the OL SU MIMO SFBC (space-frequency block code) and OL SU MIMO SM (Spatial Multiplexing) adaptation in diversity permutation. The mobile station 200 estimates the wideband CQI for both SFBC and SM, and reports the CQI and STC Rate. STC Rate 1 means SFBC with precoding and STC Rate 2 means rank-2 SM with precoding. MIMO feedback mode 0 may also be used for CQI feedback for sounding based beamforming. The mobile station 200 estimates the wideband CQI for SFBC mode (MaxMt=0b00), and report the CQI.

MIMO feedback mode 1 is used for the OL SU MIMO CDR (conjugate data repetition) with STC rate 1/2 in diversity permutation.

MIMO feedback mode 2 is used for the OL SU MIMO SM in localized permutation for frequency selective scheduling. The STC Rate indicates the preferred number of MIMO streams for SM. The subband CQI corresponds to the selected rank.

MIMO feedback mode 3 is used for the CL SU MIMO SM in localized permutation for frequency selective scheduling. The STC Rate indicates the preferred number of MIMO streams for SM. The subband CQI corresponds to the selected rank.

The MIMO feedback mode 4 is used for the CL SU MIMO using wideband beamforming with rank 1. In this mode, the mobile station 200 feedbacks the wideband CQI. The wideband CQI is estimated at the mobile station 200 assuming short-term or long-term precoding at the base station 100, according to the feedback period. The channel state information may be obtained at the base station 100 via the feedback of the correlation matrix, or via the feedback of the wideband preferred matrix index (PMI).

The MIMO feedback mode 5 is used for OL MU MIMO in localized permutation with frequency selective scheduling. In this mode, the mobile station 200 feedbacks the subband selection, MIMO stream indicator and the corresponding CQI.

The MIMO feedback mode 6 is used for CL MU MIMO in localized permutation with frequency selective scheduling. In this mode, the mobile station 200 feedbacks the subband selection, corresponding CQI, and subband PMI. The subband CQI refers to the CQI of the best PMI in the subband. Rank-1 base codebook or its subset is used to estimate the PMI in one subband.

The MIMO feedback mode 7 is used for CL MU MIMO in diversity permutation using wideband beamforming. In this mode, the mobile station 200 feedbacks the wideband CQI. The wideband CQI is estimated at the mobile station 200 assuming short-term or long-term precoding at the base station 100, according to the feedback period. The channel state information may be obtained at the base station 100 via the feedback of the correlation matrix or via the feedback of the wideband PMI.

The mobile station 200 measures MIMO feedback contents according to the allocated MIMO feedback modes in step S109.

If the feedback period allocated by the base station 100 comes in steps S111 and S113, the mobile station 200 sends the MIMO feedback using a MAC control message, an MAC extended header or a signaling header to the base station 100, depending on the requested feedback content in step S115. At this time, the mobile station 200 allocates the allocated ACID to the MIMO feedback and transmits the MIMO feedback through an uplink resource according to the allocated ACID. Single base station MIMO feedback messages and a multi base station MIMO feedback message may be used as the MAC control message. MIMO feedback extended headers may be used as the extended header. MIMO feedback report headers and correlation matrix feedback report headers may be used as the signaling header. The single base station MIMO feedback message, the multi base station MIMO feedback message, the MIMO feedback extended header, the MIMO feedback report header, and the correlation matrix feedback report header will be described hereinafter.

The mobile station 200 sends the feedback in an extended header when the following feedback information is requested:
Wideband information for MIMO feedback modes 0, 1, 4 and 7
Subband information for one subband for MIMO feedback modes 2, 3, 5 and 6

The mobile station 200 sends the feedback in a MAC control message when the following feedback information is requested:
Subband information for more than one subband for MIMO feedback modes 2, 3, 5 and 6
Multi-BS feedback

Table 3 shows an extended header for transmitting a feedback according to an embodiment of the present invention.

TABLE 3

| | Size | |
|---|---|---|
| Syntax | (bits) | Notes |
| MFEH( ) { | | |
| Type | 4 | MFEH type |
| MFM | 3 | |
| If (MFM == 0){ | | |
| Wideband CQI | 4 | |
| Wideband STC rate | 3 | |
| Zero padding | 10 | |
| } | | |
| If (MFM == 1){ | | |
| Wideband CQI | 4 | |
| Zero padding | 13 | |
| } | | |
| If (MFM == 2){ | | |
| Subband index | 5 | |
| Subband CQI | 4 | |
| Subband STC rate | 3 | |
| Zero padding | 5 | |
| } | | |
| If (MFM == 3 and Nt == 2 or 4){ | | |
| Subband index | 5 | |
| Subband CQI | 4 | |
| Subband STC rate | 2 | |
| Subband PMI | 6 | |
| } | | |
| If (MFM == 3 and Nt == 8){ | | |
| Subband index | 5 | |
| Subband CQI | 4 | |
| Subband STC rate | 3 | |
| Subband PMI | 4 | |
| Zero padding | 1 | |
| } | | |
| If (MFM == 4){ | | |
| Wideband CQI | 4 | |
| Wideband STC rate | 3 | |
| Wideband PMI | 6 | |
| Zero padding | 4 | |
| } | | |
| If (MFM == 5){ | | |
| Subband index | 5 | |
| Subband CQI | 4 | |
| Subband stream index | 2 | |
| Zero padding | 6 | |
| } | | |
| If (MFM == 6){ | | |
| Subband index | 5 | |
| Subband CQI | 4 | |
| Subband PMI | 6 | |
| Zero padding | 2 | |
| } | | |
| If (MFM == 7){ | | |
| Wideband CQI | 4 | |
| Wideband PMI | 6 | |
| Zero padding | 7 | |
| } | | |
| } | | |

As shown in Table 3, the MIMO feedback extended header according to an embodiment of the present invention includes a type field, a MIMO feedback mode field and channel information corresponding to the MIMO feedback mode.

Table 4 shows a single base station MIMO feedback message (AAI_SingleBS_MIMO_FBK message) corresponding to a MAC control message for transmitting a feedback according to an embodiment of the present invention.

TABLE 4

| Syntax | Size (bits) | Notes |
|---|---|---|
| AAI_SingleBS_MIMO_FBK_Message_Format { | | |
| Management Message Type | 8 | |
| If ( (q > 0) and ((MFM == 3) or (MFM == | | MFM and long period q are |
| 6) or (MFM == 4) or (MFM == 7)) ){ | | indicated in Feedback |
| | | Polling A-MAP IEs relevant |
| | | to currently assigned |
| | | feedback processes. |
| For (i=1; i <= Nt; i++){ | | |
| i-th diagonal entry of correlation | 1 | |
| matrix | | |
| For (j=i+1; j <= Nt; j++){ | | |
| (i,j)-th entry of correlation matrix | 4 | |
| } | | |
| } | | |
| } | | |
| MFM_bitmap | 4 | Bitmap to indicate the |
| | | MFMs for which the mobile |
| | | station is sending feedback. |
| | | It can be consistent with |
| | | current feedback |
| | | allocations corresponding |
| | | to the MFM requested by |
| | | Feedback Polling IE. LSB |
| | | #0: MFM 2 |
| | | LSB #1: MFM 3 |
| | | LSB #2: MFM 5 |
| | | LSB #3: MFM 6 |
| If (LSB #0 in MFM_bitmap == 1){ | | MFM 2 as specified in |
| | | Feedback Polling A-MAP IE |
| Best_subbands_index | variable | |
| STC_Rate | variable | If Measurement Method |
| | | Indication = 0b0: |
| | | MaxMt = 2: 1 bit |
| | | MaxMt = 3 or 4: 2 bits |
| | | MaxMt >4: 3 bits |
| | | This field can be omitted if |
| | | Measurement Method |
| | | Indication = 0b1 or if MaxMt = |
| | | 1. |
| For (m=0; m < Num_best_subbands; | | The subbands are sorted in |
| m ++){ | | order of increasing logical |
| | | index |
| Subband CQI | 4 | MCS of m-th subband |
| | | indicated by |
| | | Best_subbands_index |
| } | | |
| } | | |
| If (LSB #1 in MFM_bitmap == 1){ | | MFM 3 as specified in |
| | | Feedback Polling A-MAP IE |
| Best_subbands_index | variable | |
| STC_Rate | variable | MaxMt = 2: 1 bit |
| | | MaxMt = 3 or 4: 2 bits |
| | | MaxMt >4: 3 bits |
| | | This field can be omitted if |
| | | MaxMt = 1. |
| For (m=0; m < Num_best_subbands; | | The subbands are sorted in |
| m ++){ | | order of increasing logical |
| | | index |
| Subband CQI | 4 | MCS of m-th subband |
| | | indicated by |
| | | Best_subbands_index |
| Subband PMI | variable | PMI of m-th subband |
| | | indicated by |
| | | Best_subbands_index |
| | | Nt = 2: 3 bits |
| | | Nt = 4 and CS = 0b0: 6 bits |
| | | Nt = 4 and CS = 0b1: 4 bits |
| | | Nt = 8: 4 bits |
| } | | |
| } | | |
| If (LSB #2 in MFM_bitmap == 1){ | | MFM 5 as specified in |
| | | Feedback Polling A-MAP IE |
| Best_subbands_index | variable | |
| For (m=0; m < Num_best_subbands; | | The subbands are sorted in |
| m ++){ | | order of increasing logical |
| | | index |
| Subband CQI | 4 | MCS of m-th subband |
| | | indicated by |
| | | Best_subbands_index |
| Stream index | variable | Best stream index of m-th |
| | | subband indicated by |
| | | Best_subbands_index |
| | | If Measurement Method |
| | | Indication = 0b0: |
| | | MaxMt = 2: 1 bit |
| | | MaxMt = 3 or 4: 2 bits |
| | | If Measurement Method |
| | | Indication = 0b1: 1 bit |
| } | | |
| } | | |
| If (LSB #3 in MFM_bitmap == 1){ | | MFM 6 as specified in |
| | | Feedback Polling A-MAP IE |
| Best_subbands_index | variable | |
| For (m=0; m < Num_best_subbands; | | The subbands are sorted in |
| m ++){ | | order of increasing logical |
| | | index |
| Subband CQI | 4 | MCS of m-th subband |
| | | indicated by |
| | | Best_subbands_index |
| Subband PMI | variable | PMI of m-th subband |
| | | indicated by |
| | | Best_subbands_index |
| | | Nt = 2: 3 bits |
| | | Nt = 4 and CS = 0b0: 6 bits |
| | | Nt = 4 and CS = 0b1: 4 bits |
| | | Nt = 8: 4 bits |
| } | | |
| } | | |
| } | | |

As shown in Table 4, the single base station MIMO feedback message according to an embodiment of the present invention includes a management message type field and a MIMO feedback mode bitmap field (MFM_bitmap field). The single base station MIMO feedback message further includes channel information of one or more feedback modes for which bits in the MFM_bitmap field are set to 1. The single base station MIMO feedback message further includes a transmit correlation matrix if the long period q is larger than 0 and the MIMO feedback mode (MFM) is equal to 3, 6, 4, or 7.

In Table 4, the size of the MIMO feedback mode bitmap is smaller than the number of supported MIMO feedback modes. Particularly, the single base station MIMO feedback message of Table 4 may include only subband channel information.

The coefficients of the quantized transmit correlation matrix are fed back in Correlation Matrix Feedback Extended Header (CMFEH) when no AAI_SingleBS_MIMO_FBK message is sent in the same packet if the base station 100 is equipped with 2 or 4 transmit antennas. Otherwise, the coefficients of the quantized transmit correlation matrix are fed back in AAI_SingleBS_MIMO_FBK message. The coefficients of the quantized transmit correlation matrix are fed back in AAI_SingleBS_MIMO_FBK message if the base station 100 is equipped with 8 transmit antennas.

When a short-period MIMO feedback and a long-period MIMO feedback is located at the same frame, a channel information content of the two MIMO feedbacks is transmitted in the same one data burst.

Next, the base station 100 and the mobile station 200 start retransmission process of the MIMO feedback in step S117. That is, if the base station 100 successfully decodes the MIMO feedback, the base station 100 transmits an ACK message to the mobile station 200. However, if the base station 100 fails to decode the MIMO feedback, the base station 100 transmits a NACK message to the mobile station 100. If the mobile station 200 receives the NACK message, the mobile station 200 retransmits the MIMO feedback.

For uplink retransmissions of MIMO feedback, the base station 100 allocates an uplink resource with a resource allocation information message such as the UL Basic Assignment A-MAP IE and the ACID corresponding to the previous packet to retransmit the MIMO feedback.

Table 5 shows the uplink basic allocation A-MAP message according to an embodiment of the present invention.

TABLE 5

| | Size | |
|---|---|---|
| Syntax | (bits) | Notes |
| UL_Basic_Assignment_A-MAP_IE( ) { | | |
| ... | | |
| Resource Index | 11 | Resource index |
| | | includes location and |
| | | allocation size. |
| ... | | |
| ACID | 4 | HARQ channel |
| | | identifier |
| } | | |

As shown in Table 5, the uplink basic allocation A-MAP message includes a resource index field and an ACID field. The resource Index field includes information on the location and size of the uplink resource allocated to the HARQ channel identifier corresponding to the ACID field.

Retransmissions can obey the following rules 1-1, 1-2 and 1-3.

Next, the rule 1-1 will be described.

Rule 1-1: If the retransmission process for the previous HARQ burst reporting the previous MIMO feedback is not finished before a new HARQ burst reporting a new MIMO feedback with the same ACID is transmitted, the retransmission process for the previous HARQ burst is terminated and the new HARQ burst overrides the previous HARQ burst.

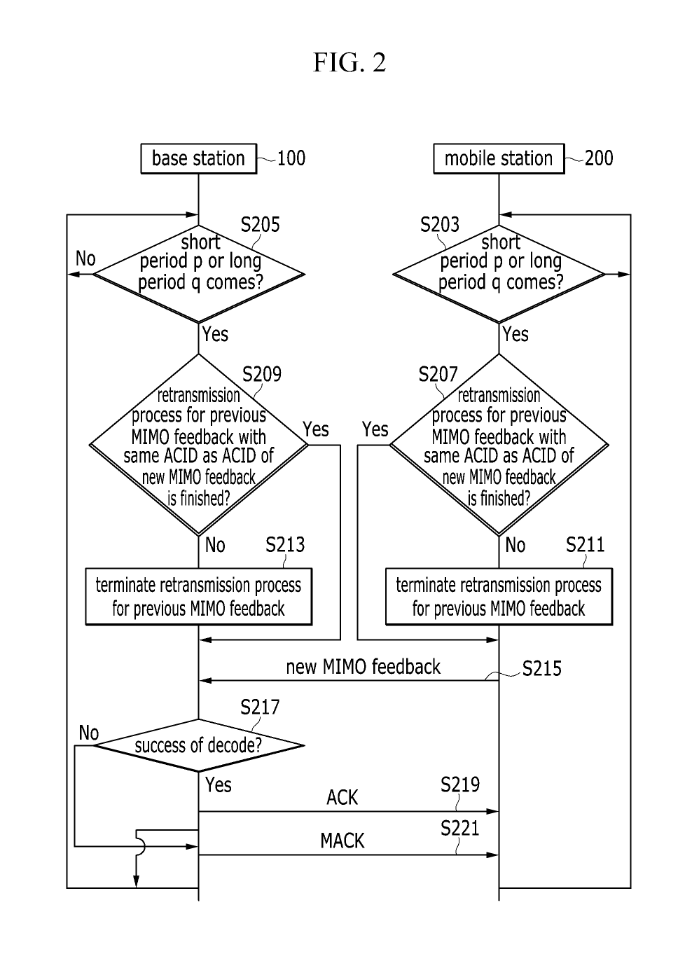

A retransmission method of MIMO feedback information according to the rule 1-1 will be described with reference to FIG. 2.

FIG. 2 shows a retransmission method of MIMO feedback information according to an embodiment of the present invention.

If the feedback period corresponding to the short period or the long period which is allocated through the feedback polling A-MAP message to the mobile station 200 comes in steps S203 and S205, before a new MIMO feedback is transmitted, the base station 100 and the mobile station 200 check whether retransmission process for the previous MIMO feedback with the same ACID as the ACID of the new MIMO feedback is finished in steps S207 and S209.

If retransmission process for the previous MIMO feedback with the same ACID as the ACID of the new MIMO feedback is not finished, the base station 100 and the mobile station 200 terminate retransmission process for the previous MIMO feedback in steps S211 and S213. That is, the base station 100 does not require retransmission for the previous MIMO feedback to the mobile station 200 through a NACK message any more. The mobile station 200 discards the previous MIMO feedback. Even if the mobile station 200 receives the NACK message from the base station 100, the mobile station 200 does not retransmit the previous MIMO feedback.

And then, the mobile station 200 transmits a new MIMO feedback corresponding to the feedback period to the base station 100 in step S215. At this time, the mobile station 200 uses a resource corresponding to the ACID allocated to the feedback period.

The base station 100 decodes the new MIMO feedback and checks success of decode in step S217. If the base station 100 successfully decodes the new MIMO feedback, the base station 100 transmits an ACK message to the mobile station 200 in step S219. However, if the base station 100 fails to decode the new MIMO feedback, the base station 100 transmits a NACK message to the mobile station 100 in step S221.

Next, the rule 1-2 will be described.

Rule 1-2: If the retransmission process for the previous HARQ burst reporting short-period feedback is not finished before a new HARQ burst reporting long-period feedback is transmitted, the retransmission process for the previous HARQ burst reporting short-period feedback is terminated and the new HARQ burst overrides it.

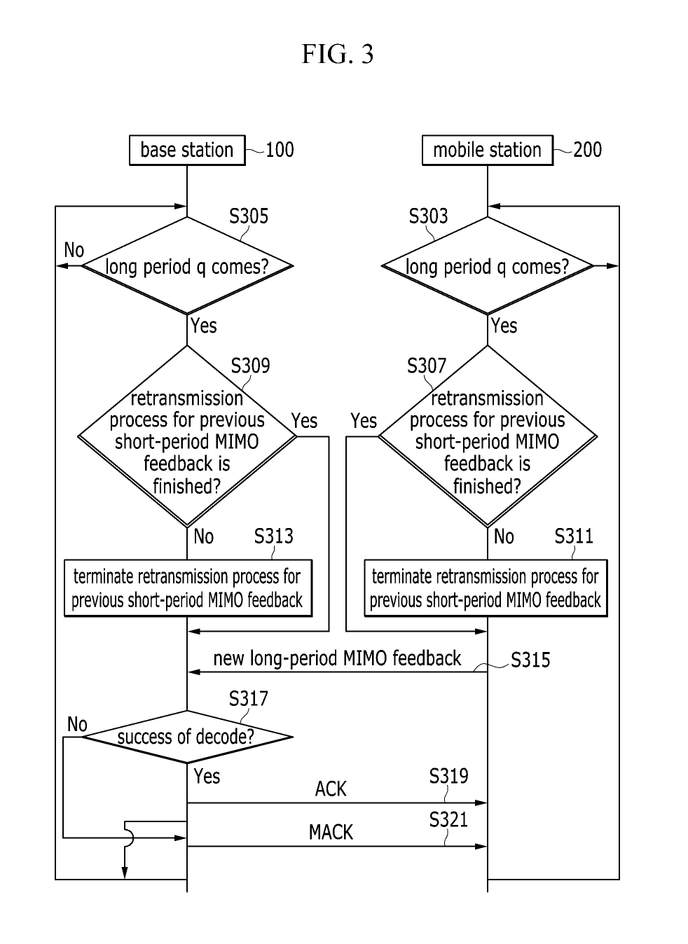

A retransmission method of MIMO feedback information according to the rule 1-2 will be described with reference to FIG. 3.

FIG. 3 shows a retransmission method of MIMO feedback information according to an embodiment of the present invention.

If the long period (q) which is allocated through the feedback polling A-MAP message to the mobile station 200 comes in steps S303 and S305, before a new long-period MIMO feedback is transmitted, the base station 100 and the mobile station 200 check whether retransmission process for the previous short-period MIMO feedback is finished in steps S307 and S309.

If a retransmission process for the previous short-period MIMO feedback is not finished, the base station 100 and the mobile station 200 terminate retransmission process for the previous short-period MIMO feedback in steps S311 and S313. That is, the base station 100 does not require retransmission for the previous short-period MIMO feedback to the mobile station 200 through a NACK message any more. The mobile station 200 discards the previous short-period MIMO feedback. Even if the mobile station 200 receives the NACK message from the base station 100, the mobile station 200 does not retransmit the previous short-period MIMO feedback.

And then, the mobile station 200 transmits the new long-period MIMO feedback corresponding to the long period (q) to the base station 100 in step S315. At this time, the mobile station 200 uses a resource corresponding to the ACID allocated to the long-period (q).

The base station 100 decodes the new long-period MIMO feedback and checks success of decode in step S317. If the base station 100 successfully decodes the new long-period MIMO feedback, the base station 100 transmits an ACK message to the mobile station 200 in step S319. However, if the base station 100 fails to decode the new long-period MIMO feedback, the base station 100 transmits a NACK message to the mobile station 100 in step S321.

Next, the rule 1-3 will be described.

Rule 1-3: If the retransmission process for the previous HARQ burst reporting long-period feedback is not finished before a new HARQ burst reporting short-period feedback is transmitted, the retransmission process for the previous HARQ burst reporting long-period feedback is carried on, but the long-period feedback content of the retransmitted packet is discarded by the base station 100 and the new HARQ burst reporting short-period feedback overrides it.

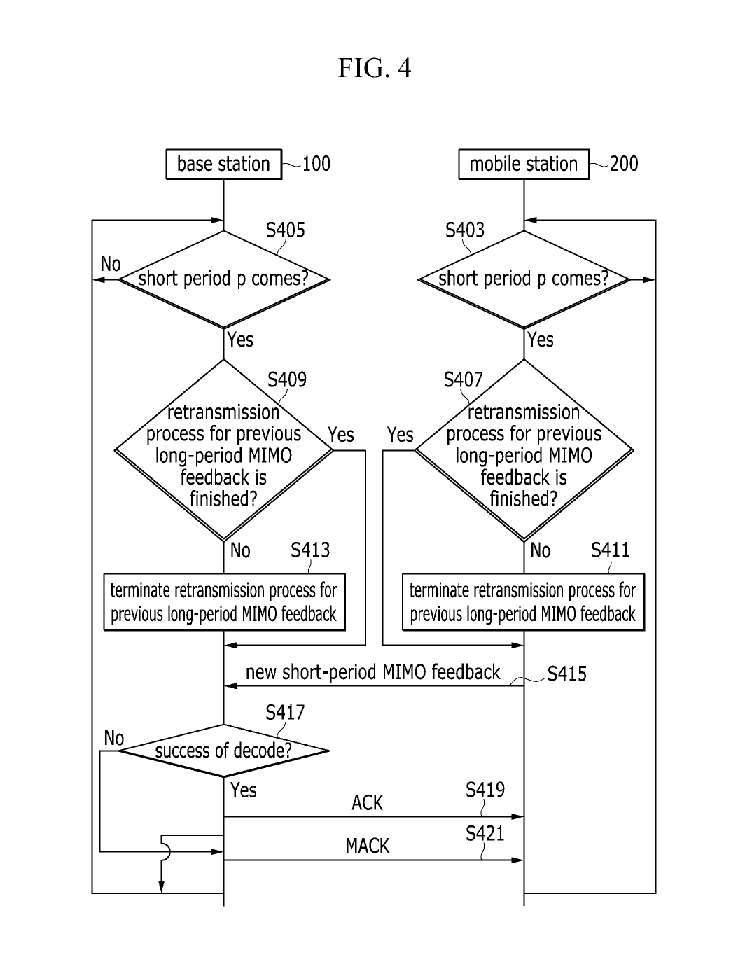

A retransmission method of MIMO feedback information according to the rule 1-3 will be described with reference to FIG. 4.

FIG. 4 shows a retransmission method of MIMO feedback information according to an embodiment of the present invention.

If the short period (p) which is allocated through the feedback polling A-MAP message to the mobile station 200 comes in steps S403 and S405, before a new short-period MIMO feedback is transmitted, the base station 100 and the mobile station 200 check whether retransmission process for the previous long-period MIMO feedback is finished in steps S407 and S409.

If a retransmission process for the previous long-period MIMO feedback is not finished, the base station 100 and the mobile station 200 terminate retransmission process for the previous long-period MIMO feedback in steps S411 and S413. That is, the base station 100 does not require retransmission for the previous long-period MIMO feedback to the mobile station 200 through a NACK message any more. The mobile station 200 discards the previous long-period MIMO feedback. Even if the mobile station 200 receives the NACK message from the base station 100, the mobile station 200 does not retransmit the previous long-period MIMO feedback.

And then, the mobile station 200 transmits the new short-period MIMO feedback corresponding to the short period (p) to the base station 100 in step S415. At this time, the mobile station 200 uses a resource corresponding to the ACID allocated to the short-period (p).

The base station 100 decodes the new short-period MIMO feedback and checks success of decode in step S417. If the base station 100 successfully decodes the new short-period MIMO feedback, the base station 100 transmits an ACK message to the mobile station 200 in step S419. However, if the base station 100 fails to decode the new short-period MIMO feedback, the base station 100 transmits a NACK message to the mobile station 100 in step S421.

However, the embodiments described above may have the following problems:

Since the MIMO Feedback Extended Header (MFEH) that is the extended header has the fixed size of 3 bytes, it can include MIMO feedback information for only one of the 8 MFMs. Further, the AAI_SingleBS_MIMO_FBK message that is the MAC control message can include only the MIMO feedback information and the quantized transmit correlation matrix for one or more subbands for MFMs 2, 3, 5 and 6.

However, the base station 100 may request to the mobile station 200 a plurality of MIMO feedback information as well as the MIMO feedback of one MFM or the transmit correlation matrix, through the feedback polling A-MAP. In this case, it is also required that the mobile station 200 configures one data burst with one ACID in one frame of a corresponding period and reports the MIMO feedback information to the base station 100. For example, when the MIMO feedbacks for MFMs 0, 1, 4 and 7 and the MIMO feedbacks for MFMs 2, 3, 5 and 6 are required, the mobile station 200 cannot configure the data burst with one MIMO Feedback Extended Header (MFEH) or one AAI_SingleBS_MIMO_FBK message.

Further, even if the mobile station 200 can configure the MIMO feedback with only the MFEH, MFEH headers corresponding to the number of MIMO feedback requests are required. Accordingly, the data size are increased so that radio resources are wasted.

Furthermore, an extended header such as the MIMO Feedback Extended Header (MFEH) or the Correlation Matrix Feedback Extended Header (CMFEH) cannot be transmitted as a stand-alone packet without the data payload configuring MAC protocol data unit (PDU) in a MAC layer. Therefore, when there is no MAC data payload to be transmitted to the base station 100 in a MIMO feedback period allocated by the base station 100, the MIMO feedback information cannot be transferred through a normal stand-alone MAC PDU packet.

In addition, a problem can occur in an HARQ process of the MIMO feedback.

That is, a retransmission process for a previous MIMO feedback using the same ACID may not occur before a new MIMO feedback is transmitted, or a retransmission for the previous MIMO feedback and a transmission of a new HARQ burst may occur at the same position. For example, when 50% HARQ retransmit rate occurs, 50% of the MIMO feedback transmission may be failed.

In the rules 1-2 and 1-3, when the base station 100 requests the MIMO feedbacks for a plurality of different MIMO feedback modes, the base station 100 requires the different MIMO contents according to its purposes, but nonetheless the mobile station 200 should discard one feedback MIMO information.

In addition, when the feedback information allocated in the short period and the feedback information allocated in the long period are transmitted at the same frame, feedback information contents may be transmitted within the same data burst. Then, since the data burst includes information corresponding to the short period and the long period, the size of the data burst is changed. Therefore, a change of resource allocation information to be transmitted in the uplink is needed such that a change of resource allocation information by the Feedback Polling A-MAP that includes HARQ channel identifier (ACID) and is previously signaled can be required.

In a MIMO feedback transmission method in a wideband wireless access system according to an embodiment of the present invention, the mobile station 200 can transmit MIMO feedback information including channel state information (CSI) or channel quality indicators (CQI) of various MIMO transmission modes that is required to apply the MIMO scheme in the wideband wireless access system.

In addition, in a MIMO feedback transmission method for improving performance of a downlink channel in a wideband wireless access system according to an embodiment of the present invention, the base station 100 can classify radio channel state information required in the various MIMO transmission modes into various feedback modes, allocate one or more MIMO feedbacks to the mobile station 200 by a feedback allocation method that indicates the short period, the long period, or the two periods at the same time through a control message such as UL Basic Assignment A-MAP or Feedback Polling A-MAP, and transmit the MIMO feedback to the mobile station through the resource allocation information.

In a MIMO feedback transmission method in a wideband wireless access system according to an embodiment of the present invention, a process of a synchronous HARQ scheme can be performed for uplink MIMO feedback data, and the mobile station 200 can receive channel identifier (ACID) information for identifying an HARQ channel from the base station 100 or can use the ACID that is provided according to the predefined rule.

In a MIMO feedback transmission method in a wideband wireless access system according to an embodiment of the present invention, for the HARQ retransmission process of the MIMO feedback, the base station 100 can allocate the uplink resource for the retransmission HARQ packet through the same ACID and the uplink MAP control message such as UL Basic Assignment A-MAP.

In a MIMO feedback transmission method in a wideband wireless access system according to an embodiment of the present invention, the mobile station 200 can transmit the MIMO feedback to the base station 100 using the feedback message such as the MAC control message, the signaling header, or the extended header according to the required feedback information.

In a MIMO feedback transmission method in a wideband wireless access system according to an embodiment of the present invention, when the base station 100 requires the MIMO feedback to the mobile station 200 in the short period or the long period and allocates one radio resource region to the mobile station 200 for transmitting the MIMO feedback, the HARQ retransmission process of the MIMO feedback at the same period can obey the following rule 2-1.

Rule 2-1: In connection with the ACID corresponding to the HARQ channel identifier for transmitting the MIMO feedback information, two or more ACIDs are used for the same period. If the previous HARQ data burst reporting the previous MIMO feedback is transmitted with a certain ACID of the two or more ACIDs, the new HARQ data burst reporting the new MIMO feedback is transmitted with the next ACID of the certain ACID in rotation way. If the retransmission process for the previous HARQ burst reporting the previous MIMO feedback is not finished before the new HARQ data burst reporting the new MIMO feedback with the same ACID i of the same period is transmitted, retransmissions can obey the following rules 2-1-1 to 2-1-4 so that the retransmission process for the previous HARQ burst and the retransmission process for the new HARQ burst can be performed at the same time.
Rule 2-1-1: For retransmitting the previous HARQ data burst, the same ACID i as the previously-used ACID and the different location from the location of the previously-used uplink radio resource are allocated through the uplink MAP control message such as the UL basic assignment A-MAP.
Rule 2-1-2: For transmitting the new HARQ data burst reporting the new MIMO feedback, the different ACID j from the previously-indicated ACID i is allocated so that HARQ channel can be distinguished. At this time, the ACID j can be allocated in descending order in rotation way. If the ACID i is the last ACID of available ACIDs, the first ACID is allocated to the new HARQ data burst.
Rule 2-1-3: The retransmission process for the previous HARQ data burst continues to be performed until the mobile station 200 recognizes through a HARQ ACK signal that the base station 100 successfully decoded the new HARQ data burst and the normal transmission has been finished.

Rule 2-1-4: The retransmission process for the previous HARQ data burst is finished if the base station 100 and the mobile station 200 recognize that the retransmission process for the new HARQ data burst is normally completed before the retransmission process for the previous HARQ data burst.

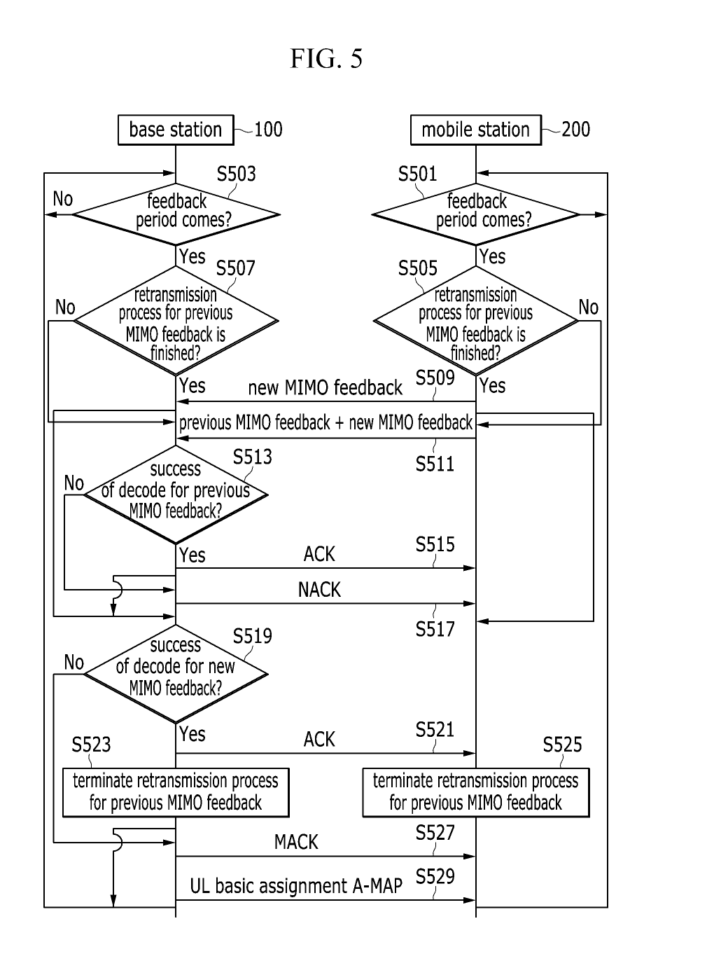

Next, referring to FIG. 5, retransmission method of MIMO feedback information according to the rule 2-1 will be described.

FIG. 5 shows retransmission method of MIMO feedback information according to an embodiment of the present invention.

For ease of description, it is assumed a previous MIMO feedback is transmitted using ACID i and a new MIMO feedback is transmitted using ACID j that is different from ACID i. The j may be set to (i+1). A base station 100 allocates one radio resource A to a mobile station for an initial transmission of a MIMO feedback. That is, a position of a resource allocated to ACID j for the initial transmission of the new MIMO feedback is the same as a position of a resource allocated to ACID i for the initial transmission of the previous MIMO feedback.

If the feedback period corresponding to the short period or the long period which is allocated through the feedback polling A-MAP message to the mobile station 200 comes in steps S501 and S503, before a new MIMO feedback is transmitted, the base station 100 and the mobile station 200 check whether retransmission process for the previous MIMO feedback with the same feedback period has been finished in steps S505 and S507.

If retransmission process for the previous MIMO feedback with the same feedback period has been finished in steps S505 and S507, the mobile station 200 transmits the new MIMO feedback with a different ACID j from the ACID i of the previous MIMO feedback through the radio resource A to the base station 100 in step S509.

The base station 100 decodes the new MIMO feedback and checks success of decode in step S519.

If the base station 100 successfully decodes the new MIMO feedback, the base station 100 transmits an ACK message to the mobile station 200 in step S521. If the base station 100 and the mobile station 200 recognize that the retransmission process for the new MIMO feedback is normally completed before the retransmission process for the previous MIMO feedback, the base station 100 and the mobile station 200 terminate the retransmission process for the previous MIMO feedback in steps S523 and S525.

In the other hand, if the base station 100 fails to decode the new MIMO feedback, the base station 100 transmits a NACK message to the mobile station 100 in step S527. And then, the base station 100 transmits the uplink basic assignment A-MAP message to the base station to assign a radio resource B of a different location from the radio resource A to ACID j for retransmitting the new MIMO feedback in step S529.

In the other word, if retransmission process for the previous MIMO feedback with the same feedback period has not been finished in steps S505 and S507, the mobile station 200 transmits the previous MIMO feedback with ACID i and the new MIMO feedback with ACID j in step S511. Because the previous MIMO feedback corresponds to a HARQ burst for retransmitting, a different radio resource is allocated to ACID i for the previous MIMO feedback through the uplink basic assignment A-MAP message. Therefore, location of a resource allocated to ACID i for the previous MIMO feedback is different from that of a resource allocated to ACID j for the new MIMO feedback.

The base station 100 decodes the previous MIMO feedback and checks success of decode in step S513.

If the base station 100 successfully decodes the previous MIMO feedback, the base station 100 transmits an ACK message to the mobile station 200 in step S515.

In the other hand, if the base station 100 fails to decode the previous MIMO feedback, the base station 100 transmits a NACK message to the mobile station 100 in step S517.

After this, the base station 100 decodes the new MIMO feedback and checks success of decode in step S519.

If the base station 100 successfully decodes the new MIMO feedback, the base station 100 transmits an ACK message to the mobile station 200 in step S521. If the base station 100 and the mobile station 200 recognize that the retransmission process for the new MIMO feedback is normally completed before the retransmission process for the previous MIMO feedback, the base station 100 and the mobile station 200 terminate the retransmission process for the previous MIMO feedback in steps S523 and S525.

In the other hand, if the base station 100 fails to decode the new MIMO feedback, the base station 100 transmits a NACK message to the mobile station 100 in step S527. And then, the base station 100 transmits the uplink basic assignment A-MAP message to the base station to assign a radio resource B of a different location from the radio resource A to ACID j for retransmitting the new MIMO feedback in step S529.

According to an MIMO feedback transmission method in the wideband wireless access system for an embodiment of the present invention, in a case that the base station 100 requires the MIMO feedback to the mobile station 200 in both the short period and the long period, allocates one radio resource region to the mobile station 200 for transmitting the MIMO feedback, allocates short-period feedback to ACID i and allocates long-period feedback to ACID j, the HARQ retransmission process of the MIMO feedback at the same period can obey the following rules 2-2 and 2-3.

Rule 2-2: If the retransmission process for the previous HARQ data burst reporting the short-period MIMO feedback is not finished before a new HARQ data burst reporting new long-period MIMO feedback is transmitted, retransmissions can obey the following rules 2-2-1 to 2-2-3 so that the retransmission process for the previous HARQ data burst reporting the short-period MIMO feedback and the retransmission process for the new HARQ data burst reporting the new long-period MIMO feedback can be performed at the same time.
Rule 2-2-1: For retransmitting the previous HARQ data burst reporting the short-period MIMO feedback, the different location from the location of the previously-used uplink radio resource are allocated through the uplink MAP control message such as the UL basic assignment A-MAP with the previously-used ACID.
Rule 2-2-2: The retransmission process for the previous HARQ data burst reporting the short-period MIMO feedback continues to be performed until the mobile station 200 recognizes through a HARQ ACK signal that the base station 100 successfully decoded the new HARQ data burst reporting the long-period MIMO and the normal transmission has been finished.
Rule 2-2-3: The retransmission process for the previous HARQ data burst reporting the short-period MIMO feedback is finished if the mobile station 200 recognizes that the retransmission process for the new HARQ data burst reporting the long-period MIMO feedback is normally completed before the retransmission process for the previous HARQ data burst reporting the short-period MIMO feedback.

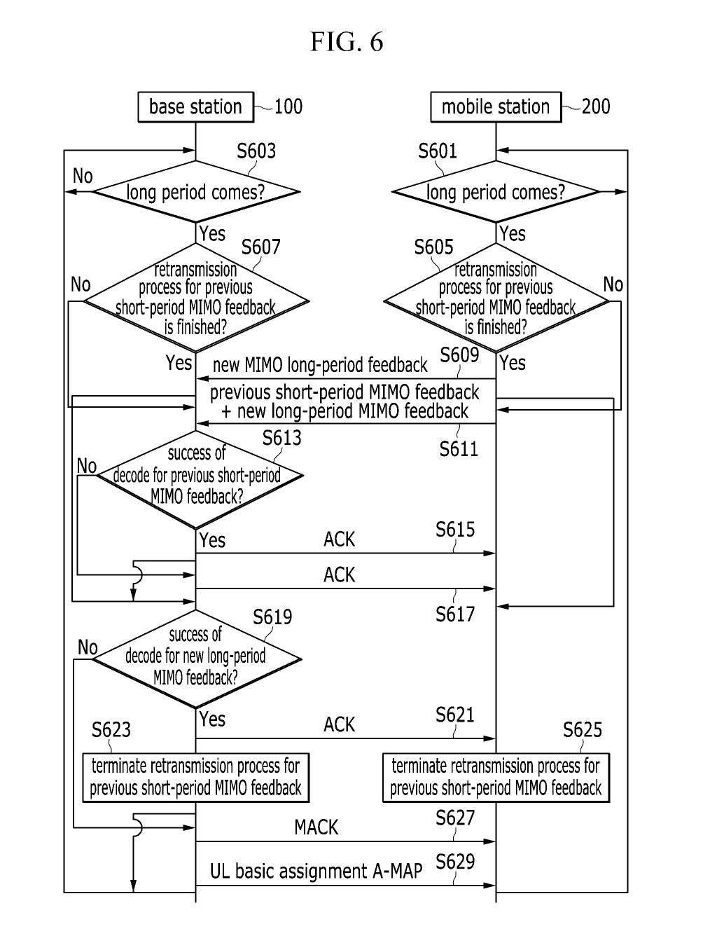

Next, referring to FIG. 6, retransmission method of MIMO feedback information according to the rule 2-2 will be described.

FIG. 6 shows retransmission method of MIMO feedback information according to an embodiment of the present invention.

For ease of description, it is assumed a short-period MIMO feedback is transmitted using ACID i and a long-period MIMO feedback is transmitted using ACID k that is different from ACID i. A base station 100 allocates one radio resource A to a mobile station for an initial transmission of a MIMO feedback. That is, a position of a resource allocated to ACID k for the initial transmission of the long-period MIMO feedback is the same as a position of a resource allocated to ACID i for the initial transmission of the short-period MIMO feedback.

If the long period which is allocated through the feedback polling A-MAP message to the mobile station 200 comes in steps S601 and S603, before a new long-period MIMO feedback is transmitted, the base station 100 and the mobile station 200 check whether retransmission process for the previous short-period MIMO feedback with the same transmission timing has been finished in steps S605 and S607.

If retransmission process for the previous short-period MIMO feedback with the same transmission timing has been finished in steps S605 and S607, the mobile station 200 transmits the new long-period MIMO feedback with ACID k through the radio resource A to the base station 100 in step S609.

The base station 100 decodes the new long-period MIMO feedback and checks success of decode in step S619.

If the base station 100 successfully decodes the new long-period MIMO feedback, the base station 100 transmits an ACK message to the mobile station 200 in step S621. If the base station 100 and the mobile station 200 recognize that the retransmission process for the new long-period MIMO feedback is normally completed before the retransmission process for the previous short-period MIMO feedback, the base station 100 and the mobile station 200 terminate the retransmission process for the previous short-period MIMO feedback in steps S623 and S625.

In the other hand, if the base station 100 fails to decode the new long-period MIMO feedback, the base station 100 transmits a NACK message to the mobile station 100 in step S627. And then, the base station 100 transmits the uplink basic assignment A-MAP message to the base station to assign a radio resource B of a different location from the radio resource A to ACID k for retransmitting the new long-period MIMO feedback in step S629. After this, at every advent of the long period, the mobile station 100 retransmits the new long-period MIMO feedback with ACID k through the radio resource B of the different location.

In the other word, if retransmission process for the previous short-period MIMO feedback with the same transmission timing has not been finished in steps S605 and S607, the mobile station 200 transmits the previous short-period MIMO feedback with ACID i and the new long-period MIMO feedback with ACID k in step S611. Because the previous short-period MIMO feedback corresponds to a HARQ burst for retransmitting, a different radio resource is allocated to ACID i for the previous short-period MIMO feedback through the uplink basic assignment A-MAP message. Therefore, location of a resource allocated to ACID i for the previous short-period MIMO feedback is different from that of a resource allocated to ACID k for the new long-period MIMO feedback.

The base station 100 decodes the previous short-period MIMO feedback and checks success of decode in step S613.

If the base station 100 successfully decodes the previous short-period MIMO feedback, the base station 100 transmits an ACK message to the mobile station 200 in step S615.

In the other hand, if the base station 100 fails to decode the previous short-period MIMO feedback, the base station 100 transmits a NACK message to the mobile station 100 in step S617.

After this, the base station 100 decodes the new long-period MIMO feedback and checks success of decode in step S619.

If the base station 100 successfully decodes the new long-period MIMO feedback, the base station 100 transmits an ACK message to the mobile station 200 in step S621. If the base station 100 and the mobile station 200 recognize that the retransmission process for the new long-period MIMO feedback is normally completed before the retransmission process for the previous short-period MIMO feedback, the base station 100 and the mobile station 200 terminate the retransmission process for the previous short-period MIMO feedback in steps S623 and S625.

In the other hand, if the base station 100 fails to decode the new long-period MIMO feedback, the base station 100 transmits a NACK message to the mobile station 100 in step S627. And then, the base station 100 transmits the uplink basic assignment A-MAP message to the base station to assign a radio resource B of a different location from the radio resource A to ACID k for retransmitting the new long-period MIMO feedback in step S629.

Rule 2-3: If the retransmission process for the previous HARQ data burst reporting the long-period MIMO feedback is not finished before a new HARQ data burst reporting new short-period MIMO feedback is transmitted, retransmissions can obey the following rules 2-3-1 to 2-3-3 so that the retransmission process for the previous HARQ data burst reporting the long-period MIMO feedback and the retransmission process for the new HARQ data burst reporting the new short-period MIMO feedback can be performed at the same time.
Rule 2-3-1: For retransmitting the previous HARQ data burst reporting the long-period MIMO feedback, the different location from the location of the previously-used uplink radio resource are allocated through the uplink MAP control message such as the UL basic assignment A-MAP with the previously-used ACID.
Rule 2-3-2: The retransmission process for the previous HARQ data burst reporting the long-period MIMO feedback continues to be performed until the mobile station 200 recognizes through a HARQ ACK signal that the base station 100 successfully decoded the new HARQ data burst reporting the short-period MIMO and the normal transmission has been finished.
Rule 2-3-3: The retransmission process for the previous HARQ data burst reporting the long-period MIMO feedback is finished if the mobile station 200 recognizes that the retransmission process for the new HARQ data burst reporting the short-period MIMO feedback is normally completed before the retransmission process for the previous HARQ data burst reporting the long-period MIMO feedback.

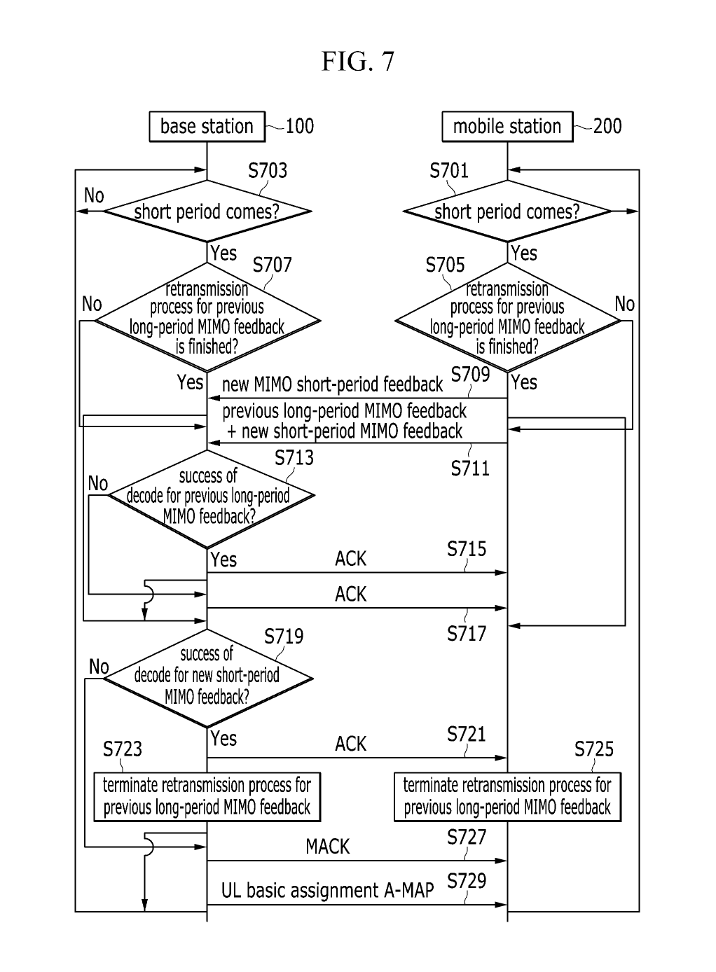

Next, referring to FIG. 7, retransmission method of MIMO feedback information according to the rule 2-3 will be described.

FIG. 7 shows retransmission method of MIMO feedback information according to an embodiment of the present invention.

For ease of description, it is assumed a short-period MIMO feedback is transmitted using ACID i and a long-period MIMO feedback is transmitted using ACID k that is different from ACID i. A base station 100 allocates one radio resource A to a mobile station for an initial transmission of a MIMO feedback. That is, a position of a resource allocated to ACID k for the initial transmission of the long-period MIMO feedback is the same as a position of a resource allocated to ACID i for the initial transmission of the short-period MIMO feedback.

If the short period which is allocated through the feedback polling A-MAP message to the mobile station 200 comes in steps S701 and S703, before a new short-period MIMO feedback is transmitted, the base station 100 and the mobile station 200 check whether retransmission process for the previous long-period MIMO feedback with the same transmission timing has been finished in steps S705 and S707.

If retransmission process for the previous long-period MIMO feedback with the same transmission timing period has been finished in steps S705 and S707, the mobile station 200 transmits the new short-period MIMO feedback with ACID i through the radio resource A to the base station 100 in step S709.

The base station 100 decodes the new short-period MIMO feedback and checks success of decode in step S719.

If the base station 100 successfully decodes the new short-period MIMO feedback, the base station 100 transmits an ACK message to the mobile station 200 in step S721. If the base station 100 and the mobile station 200 recognize that the retransmission process for the new short-period MIMO feedback is normally completed before the retransmission process for the previous long-period MIMO feedback, the base station 100 and the mobile station 200 terminate the retransmission process for the previous long-period MIMO feedback in steps S723 and S725.

In the other hand, if the base station 100 fails to decode the new short-period MIMO feedback, the base station 100 transmits a NACK message to the mobile station 100 in step S727. And then, the base station 100 transmits the uplink basic assignment A-MAP message to the base station to assign a radio resource B of a different location from the radio resource A to ACID i for retransmitting the new short-period MIMO feedback in step S729. After this, at every advent of the short period, the mobile station 100 retransmits the new short-period MIMO feedback with ACID i through the radio resource B of the different location.

In the other word, if retransmission process for the previous long-period MIMO feedback with the same transmission timing has not been finished in steps S705 and S707, the mobile station 200 transmits the previous long-period MIMO feedback with ACID k and the new short-period MIMO feedback with ACID i in step S711. Because the previous long-period MIMO feedback corresponds to a HARQ burst for retransmitting, a different radio resource is allocated to ACID k for the previous long-period MIMO feedback through the uplink basic assignment A-MAP message. Therefore, location of a resource allocated to ACID k for the previous long-period MIMO feedback is different from that of a resource allocated to ACID i for the new short-period MIMO feedback.

The base station 100 decodes the previous long-period MIMO feedback and checks success of decode in step S713.

If the base station 100 successfully decodes the previous long-period MIMO feedback, the base station 100 transmits an ACK message to the mobile station 200 in step S715.

In the other hand, if the base station 100 fails to decode the previous long-period MIMO feedback, the base station 100 transmits a NACK message to the mobile station 100 in step S717.

After this, the base station 100 decodes the new short-period MIMO feedback and checks success of decode in step S719.

If the base station 100 successfully decodes the new short-period MIMO feedback, the base station 100 transmits an ACK message to the mobile station 200 in step S721. If the base station 100 and the mobile station 200 recognize that the retransmission process for the new short-period MIMO feedback is normally completed before the retransmission process for the previous long-period MIMO feedback, the base station 100 and the mobile station 200 terminate the retransmission process for the previous long-period MIMO feedback in steps S723 and S725.

In the other hand, if the base station 100 fails to decode the new short-period MIMO feedback, the base station 100 transmits a NACK message to the mobile station 100 in step S727. And then, the base station 100 transmits the uplink basic assignment A-MAP message to the base station to assign a radio resource B of a different location from the radio resource A to ACID i for retransmitting the new short-period MIMO feedback in step S729.

According to an MIMO feedback transmission method in the wideband wireless access system for an embodiment of the present invention, in a case that the base station 100 requires the MIMO feedback to the mobile station 200 in both the short period and the long period, allocates one radio resource region to the mobile station 200 for transmitting the MIMO feedback, allocates short-period feedback to ACID i, allocates long-period feedback to ACID j, and the frame location for transmitting the short-period feedback is the same as the frame location for transmitting the long-period feedback, the transmission process of the MIMO feedback at the same period can obey the following rule 2-4.

Rule 2-4: If a long-period MIMO feedback and a short-period MIMO feedback concurrently occur, the two MIMO feedbacks can be transmitted through one data burst according to Rules 2-4-1 and 2-4-2.
Rule 2-4-1: If the size of the previously-allocated radio resource cannot accommodate the size of a data burst which is composed of the long-period MIMO feedback and the short-period MIMO feedback, the base station 100 re-allocates a uplink radio resource for transmitting MIMO feedback through the uplink MAP control message such as the UL basic assignment A-MAP so that the re-allocated uplink radio resource can accommodate the size of newly-composed data burst.
Rule 2-4-2: At this time, the base station 100 can designate the ACID corresponding to the HARQ channel identifier as one of the ACID i for the short-period feedback or the ACID k for the long period feedback.

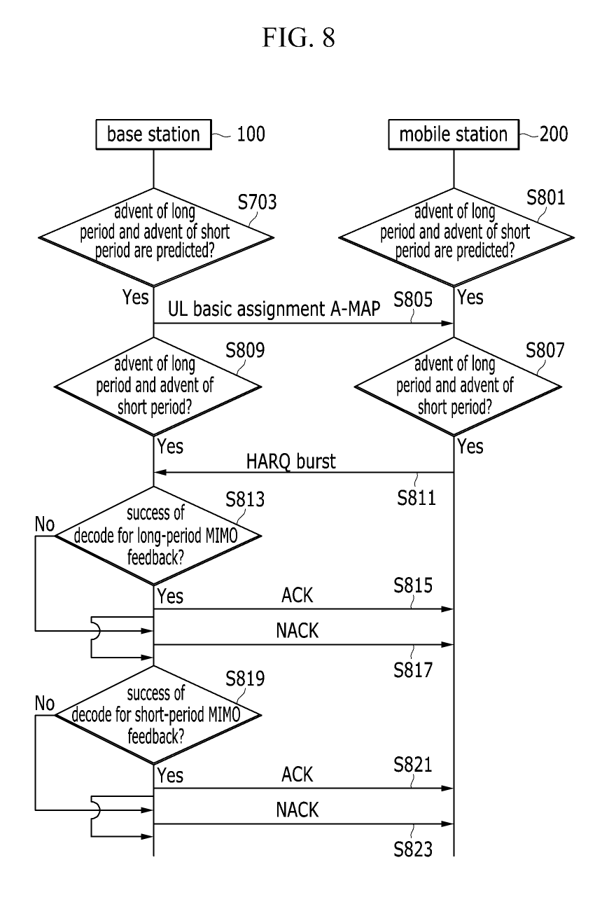

Next, referring to FIG. 8, transmission method of MIMO feedback information according to the rule 2-4 will be described.

FIG. 8 shows retransmission method of MIMO feedback information according to an embodiment of the present invention.

For ease of description, it is assumed a short-period MIMO feedback is transmitted using ACID i and a long-period MIMO feedback is transmitted using ACID k that is different from ACID i. A base station 100 allocates one radio resource A to a mobile station for an initial transmission of a MIMO feedback. That is, a position of a resource allocated to ACID k for the initial transmission of the long-period MIMO feedback is the same as a position of a resource allocated to ACID i for the initial transmission of the short-period MIMO feedback.

If the base station 100 and the mobile station 200 predict that the advent of the long period and the advent of the short period will coincide in steps S801 and S803, the base station 100 transmits the uplink basic assignment A-MAP message to the mobile station 200 to assign ACID i or ACID k to the different size of a radio resource (C) which accommodate both the long-period MIMO feedback and the short-period MIMO feedback in step S805.

At the concurrent advent of both the long period and the short period in steps S807 and S809, the mobile station 200 generates a HARQ burst including both the long-period MIMO feedback and the short-period MIMO feedback, and transmits the HARQ burst with ACID i or ACID j through the newly-allocated radio resource C in step S811.

The base station 100 decodes the long-period MIMO feedback and checks success of decode in step S813.

If the base station 100 successfully decodes the long-period MIMO feedback, the base station 100 transmits an ACK message to the mobile station 200 in step S815.

In the other hand, if the base station 100 fails to decode the long-period MIMO feedback, the base station 100 transmits a NACK message to the mobile station 100 in step S817.

The base station 100 decodes the short-period MIMO feedback and checks success of decode in step S819.

If the base station 100 successfully decodes the short-period MIMO feedback, the base station 100 transmits an ACK message to the mobile station 200 in step S821.

In the other hand, if the base station 100 fails to decode the short-period MIMO feedback, the base station 100 transmits a NACK message to the mobile station 100 in step S823.

According to an MIMO feedback transmission method in the wideband wireless access system for an embodiment of the present invention, the base station 100 can classify wireless channel state information required for various MIMO transmission modes to various types of feedback modes to perform multiple allocation for allocating a plurality of MIMO feedbacks to the mobile station 200, and the mobile station 200 can compose MIMO feedback information through this resource allocation information according to Rules 2-5 and 2-6.

Rule 2-5: The mobile station 200 transmits MIMO feedback information through MIMO Feedback Extended Header (MFEH) in which MFM_bitmap corresponding to a bitmap for identifying MIMO feedback modes is used so that the mobile station 200 can compose an extended header including plural pieces of channel information as shown in Table 6. The MFM_bitmap can correspond to the bitmap which the mobile station 200 has received through the feedback polling A-MAP message.

TABLE 6

| | Size | |
|---|---|---|
| Syntax | (bits) | Notes |
| MFEH( ) { | | |
| Type | 4 | MFEH type |
| MFM_bitmap | 8 | Bitmap to indicate the MFMs for |
| | | which the mobile station is sending |
| | | feedback. It can be consistent with |
| | | current feedback allocations |
| | | corresponding to the MFM |
| | | requested by Feedback Polling IE. |
| | | LSB #0: MFM 0 |
| | | LSB #1: MFM 1 |
| | | LSB #2: MFM 2 |
| | | LSB #3: MFM 3 |
| | | LSB #4: MFM 4 |
| | | LSB #5: MFM 5 |
| | | LSB #6: MFM 6 |
| | | LSB #7: MFM 7 |
| If (LSB#0 in MFM_bitmap == 1){ | | MFM 0 as specified in Feedback |
| | | Polling A-MAP IE |
| Wideband CQI | 4 | |
| Wideband STC rate | 3 | |
| } | | |
| If (LSB#1 in MFM_bitmap == 1){ | | MFM 1 as specified in Feedback |
| | | Polling A-MAP IE |
| Wideband CQI | 4 | |
| } | | |
| If (LSB#2 in MFM_bitmap == 1){ | | MFM 2 as specified in Feedback |
| | | Polling A-MAP IE |
| Subband index | 5 | |
| Subband CQI | 4 | |
| Subband STC rate | 3 | |
| } | | |
| If (LSB#3 in MFM_bitmap == 1 and | | MFM 3 for Nₜ = 2 or 4 as specified in |
| Nₜ == 2 or 4){ | | Feedback Polling A-MAP IE |
| Subband index | 5 | |
| Subband CQI | 4 | |
| Subband STC rate | 2 | |
| Subband PMI | 6 | |
| } | | |
| If (LSB#3 in MFM_bitmap == 1 and | | MFM 3 for Nₜ = 8 as specified in |
| Nₜ == 8){ | | Feedback Polling A-MAP IE |
| Subband index | 5 | |
| Subband CQI | 4 | |
| Subband STC rate | 3 | |
| Subband PMI | 4 | |
| } | | |
| If (LSB#4 in MFM_bitmap == 1){ | | MFM 4 as specified in Feedback |
| | | Polling A-MAP IE |
| Wideband CQI | 4 | |
| Wideband STC rate | 3 | |
| Wideband PMI | 6 | |
| } | | |
| If (LSB#5 in MFM_bitmap == 1){ | | MFM 5 as specified in Feedback |
| | | Polling A-MAP IE |
| Subband index | 5 | |
| Subband CQI | 4 | |
| Subband stream index | 2 | |
| } | | |
| If (LSB#6 in MFM_bitmap == 1){ | | MFM 6 as specified in Feedback |
| | | Polling A-MAP IE |
| Subband index | 5 | |
| Subband CQI | 4 | |
| Subband PMI | 6 | |
| } | | |
| If (LSB#7 in MFM_bitmap == 1){ | | MFM 7 as specified in Feedback |
| | | Polling A-MAP IE |
| Wideband CQI | 4 | |
| Wideband PMI | 6 | |
| } | | |
| Reserved | variable | For byte alignment |
| } | | |

As shown in Table 6, the MIMO feedback extended header according to an embodiment of the present invention includes a type field and a MIMO feedback mode bitmap field (MFM_bitmap field). And the MIMO feedback extended header further includes channel information of one or more feedback modes for which bits in the MFM_bitmap field are set to 1.

Rule 2-6: The mobile station 200 transmits MIMO feedback information through single base station MIMO feedback message (AAI_SingleBS_MIMO_FBK message) or multi base station MIMO feedback message (AAI_MultiBS_MIMO_FBK message) corresponding to the MAC control message. Table 7 shows the AAI_SingleBS_MIMO_FBK message. As shown in Table 7, the AAI_SingleBS_MIMO_FBK message can include plural pieces of various MFM channel information so that one feedback message can accommodate all feedback mode. That is, the feedback message is composed so that it can accommodate MIMO feedback modes 0, 1, 4, and 7.

TABLE 7

| | Size | |
|---|---|---|
| Syntax | (bits) | Notes |
| AAI_SingleBS_MIMO_FBK_Message_Format { | | |
| Management Message Type | 8 | |
| If ( (q > 0) and ((MFM == 3) or (MFM == | | MFM and long period q are |
| 6) or (MFM == 4) or (MFM == 7)) ){ | | indicated in Feedback Polling |
| | | A-MAP IEs relevant to currently |
| | | assigned feedback processes. |
| For (i=1; i <= Nₜ; i++){ | | |
| i-th diagonal entry of correlation | 1 | |
| matrix | | |
| For (j=i+1; j <= Nₜ; j++){ | | |
| (i,j)-th entry of correlation | 4 | |
| matrix | | |
| } | | |
| } | | |
| } | | |
| MFM_bitmap | 8 | Bitmap to indicate the MFMs for |
| | | which the mobile station is |
| | | sending feedback. It can be |
| | | consistent with current feedback |
| | | allocations corresponding to the |
| | | MFM requested by Feedback |
| | | Polling IE. LSB #0: MFM 0 |
| | | LSB #1: MFM 1 |
| | | LSB #2: MFM 2 |
| | | LSB #3: MFM 3 |
| | | LSB #4: MFM 4 |
| | | LSB #5: MFM 5 |
| | | LSB #6: MFM 6 |
| | | LSB #7: MFM 7 |
| If (LSB #0 in MFM_bitmap == 1){ | | MFM 0 as specified in Feedback |
| | | Polling A-MAP IE |
| Wideband CQI | 4 | |
| Wideband STC rate | 3 | |
| } | | |
| If (LSB #1 in MFM_bitmap == 1){ | | MFM 1 as specified in Feedback |
| | | Polling A-MAP IE |
| Wideband CQI | 4 | |
| } | | |
| If (LSB #2 in MFM_bitmap == 1){ | | MFM 2 as specified in Feedback |
| | | Polling A-MAP IE |
| Best_subbands_index | variable | |
| STC_Rate | variable | If Measurement Method |
| | | Indication = 0b0: |
| | | MaxMₜ = 2: 1 bit |
| | | MaxMₜ = 3 or 4: 2 bits |
| | | MaxMₜ > 4: 3 bits |
| | | This field can be omitted if |
| | | Measurement Method |
| | | Indication = 0b1 or if MaxMₜ = 1. |
| For (m=0; m < Num_best_subbands; | | The subbands are sorted in order |
| m ++){ | | of increasing logical index |
| Subband CQI | 4 | MCS of m-th subband indicated by |
| | | Best_subbands_index |
| } | | |
| } | | |
| If (LSB #3 in MFM_bitmap == 1){ | | MFM 3 as specified in Feedback |
| | | Polling A-MAP IE |
| Best_subbands_index | variable | |
| STC_Rate | variable | MaxMₜ = 2: 1 bit |
| | | MaxMₜ = 3 or 4: 2 bits |
| | | MaxMₜ > 4: 3 bits |
| | | This field can be omitted if MaxMₜ = |
| | | 1. |
| For (m=0; m < Num_best_subbands; | | The subbands are sorted in order |
| m ++){ | | of increasing logical index |
| Subband CQI | 4 | MCS of m-th subband indicated by |
| | | Best_subbands_index |
| Subband PMI | variable | PMI of m-th subband indicated by |
| | | Best_subbands_index |
| | | Nₜ = 2: 3 bits |
| | | Nₜ = 4 and CS = 0b0: 6 bits |
| | | Nₜ = 4 and CS = 0b1: 4 bits |
| | | Nₜ = 8: 4 bits |
| } | | |
| } | | |
| If (LSB #4 in MFM_bitmap == 1){ | | MFM 4 as specified in Feedback |
| | | Polling A-MAP IE |
| Wideband CQI | 4 | |
| Wideband STC rate | 3 | |
| Wideband PMI | 6 | |
| } | | |
| If (LSB #5 in MFM_bitmap == 1){ | | MFM 5 as specified in Feedback |
| | | Polling A-MAP IE |
| Best_subbands_index | variable | |
| For (m=0; m < Num_best_subbands; | | The subbands are sorted in order |
| m ++){ | | of increasing logical index |
| Subband CQI | 4 | MCS of m-th subband indicated by |
| | | Best_subbands_index |
| Stream index | variable | Best stream index of m-th |
| | | subband indicated by |
| | | Best_subbands_index |
| | | If Measurement Method |
| | | Indication = 0b0: |
| | | MaxMₜ = 2: 1 bit |
| | | MaxMₜ = 3 or 4: 2 bits |
| | | If Measurement Method |
| | | Indication = 0b1: 1 bit |
| } | | |
| } | | |
| If (LSB #6 in MFM_bitmap == 1){ | | MFM 6 as specified in Feedback |
| | | Polling A-MAP IE |
| Best_subbands_index | variable | |
| For (m=0; m < Num_best_subbands; | | The subbands are sorted in order |
| m ++){ | | of increasing logical index |
| Subband CQI | 4 | MCS of m-th subband indicated by |
| | | Best_subbands_index |
| Subband PMI | variable | PMI of m-th subband indicated by |
| | | Best_subbands_index |
| | | Nₜ = 2: 3 bits |
| | | Nₜ = 4 and CS = 0b0: 6 bits |
| | | Nₜ = 4 and CS = 0b1: 4 bits |
| | | Nₜ = 8: 4 bits |
| } | | |
| } | | |
| If (LSB #7 in MFM_bitmap == 1){ | | MFM 7 as specified in Feedback |
| | | Polling A-MAP IE |
| Wideband CQI | 4 | |
| Wideband PMI | 6 | |
| } | | |
| } | | |

As shown in Table 7, the single base station MIMO feedback message according to an embodiment of the present invention includes a management message type field and a MIMO feedback mode bitmap field (MFM_bitmap field). And the single base station MIMO feedback message further includes channel information of one or more feedback modes for which bits in the MFM_bitmap field are set to 1. Also, the single base station MIMO feedback message further includes a transmit correlation matrix if the long period q is lager that 0 and the MIMO feedback mode (MFM) is equal to 3, 6, 4, or 7.

In Table 7, the size of the MIMO feedback mode bitmap is equal to the number of supported MIMO feedback modes.

The mobile station 200 cannot transmit an extended header such as the MIMO feedback extended header (MFEH) or the correlation matrix feedback extended header (CMFEH) through a stand-alone MAC protocol data unit (PDU) without a data payload for composing the MAC PDU in the MAC layer. Therefore, according to an MIMO feedback transmission method in the wideband wireless access system for an embodiment of the present invention, the mobile station 200 reconstructs MAC signaling headers by using the following ways so that the mobile station 200 can transmit MIMO feedback information through a stand-alone packet without a data payload to the base station 100.

Rule 2-7: To report the MIMO feedback for channel information according to various types of MIMO feedback modes, the mobile station 200 transmits channel information according to the MIMO feedback mode through a MAC signaling header as shown in Table 8 so that the mobile station 200 can transmit channel information through a stand-alone MAC PDU packet without a data payload for composing the MAC PDU.

TABLE 8

| | Size | |
|---|---|---|
| Syntax | (bits) | Notes |
| MIMO Feedback Report Header ( ) { | | |
| FID | 4 | Flow Identifier. |
| Type | 4 | MAC signaling header |
| | | type |
| MFM | 3 | MIMO feedback mode |
| If (MFM == 0, 1, 4, or 7) { | | |
| Wideband CQI | 4 | |
| If (MFM == 0, or 4) { | | |
| Wideband STC rate | 4 | |
| } | | |
| If (MFM == 4, or 7) { | | |
| Wideband PMI | 6 | |
| } | | |
| } | | |
| If (MFM == 2, 3, 5, or 6) { | | |
| Subband index | 5 | |
| Subband CQI | 4 | |
| If (MFM == 2 or 3) { | | |
| Subband STC rate | 3 | |
| } | | |
| If (MFM == 3 or 6) { | | |
| Subband PMI | 6 | |
| } | | |
| If (MFM == 5) { | | |
| Subband stream index | 2 | |
| } | | |
| } | | |
| Padding | variable | For byte alignment |
| } | | |

As shown in Table 8, the MIMO feedback report header corresponding to an signaling header according to an embodiment of the present invention includes a flow identifier field, a type field, a MIMO feedback mode field and channel information corresponding to the MIMO feedback mode.

Rule 2-8: To report the MIMO feedback for channel information according to various types of MIMO feedback modes, the mobile station 200 can use a MIMO feedback report header as shown in Table 9 so that one MAC signaling header can accommodate channel information according to plural MIMO feedback modes and the mobile station 200 can transmit channel information to the base station 100 through a stand-alone MAC PDU packet without a data payload for composing the MAC PDU. The MIMO feedback report header of Table 9 can accommodate three MFM feedback contents for wideband information corresponding to MFMs 0, 1, 4 and 7. And the MIMO feedback report header of Table 9 can accommodate one MFM feedback content for subband information corresponding to MFMs 2, 3, 4 and 6.

Table 9 shows a MIMO Feedback Report Header according to an embodiment of the present invention.

TABLE 9

| | Size | |
|---|---|---|
| Syntax | (bits) | Notes |
| MIMO Feedback Report Header ( ) { | | |
| FID | 4 | Flow Identifier. |
| Type | 4 | MAC signaling header type- |
| MFM_bitmap | 8 | Bitmap to indicate the MFMs for |
| | | which the mobile station is |
| | | sending feedback. It can be |
| | | consistent with current feedback |
| | | allocations corresponding to the |
| | | MFM requested by Feedback |
| | | Polling A-MAP IE. LSB #0: MFM 0 |
| | | LSB #1: MFM 1 |
| | | LSB #2: MFM 2 |
| | | LSB #3: MFM 3 |
| | | LSB #4: MFM 4 |
| | | LSB #5: MFM 5 |
| | | LSB #6: MFM 6 |
| | | LSB #7: MFM 7 |
| If (LSB#0 in MFM_bitmap == 1){ | | |
| Wideband CQI | 4 | |
| Wideband STC rate | 3 | |
| } | | |
| If (LSB#1 in MFM_bitmap == 1){ | | |
| Wideband CQI | 4 | |
| } | | |
| If (LSB#2 in MFM_bitmap == 1){ | | |
| Subband index | 5 | |
| Subband CQI | 4 | |
| Subband STC rate | 3 | |
| } | | |
| If (LSB#3 in MFM_bitmap == 1 and Nₜ | | |
| == 2 or 4){ | | |
| Subband index | 5 | |
| Subband CQI | 4 | |
| Subband STC rate | 2 | |
| Subband PMI | 6 | |
| } | | |
| If (LSB#3 in MFM_bitmap == 1 and Nₜ | | |
| == 8){ | | |
| Subband index | 5 | |
| Subband CQI | 4 | |
| Subband STC rate | 3 | |
| Subband PMI | 4 | |
| } | | |
| If (LSB#4 in MFM_bitmap == 1){ | | |
| Wideband CQI | 4 | |
| Wideband STC rate | 3 | |
| Wideband PMI | 6 | |
| } | | |
| If (LSB#5 in MFM_bitmap == 1){ | | |
| Subband index | 5 | |
| Subband CQI | 4 | |
| Subband stream index | 2 | |
| } | | |
| If (LSB#6 in MFM_bitmap == 1){ | | |
| Subband index | 5 | |
| Subband CQI | 4 | |
| Subband PMI | 6 | |
| } | | |
| If (LSB#7 in MFM_bitmap == 1){ | | |
| Wideband CQI | 4 | |
| Wideband PMI | 6 | |
| } | | |
| } | | |

As shown in Table 9, the MIMO feedback report header corresponding to an signaling header according to another embodiment of the present invention includes a flow identifier field, a type field, a MIMO feedback mode bitmap field (MFM_bitmap field). And the MIMO feedback report header further includes channel information of one or more feedback modes for which bits in the MFM_bitmap field are set to 1.

Rule 2-9: To report the MIMO feedback for transmit Correlation Matrix of a specific mode, e.g. MFM 3, 4, 6 or 7, among various types of feedback modes in connection with wireless channel state information required in various MIMO transmission modes, the mobile station 200 transmits MIMO feedback information for Correlation Matrix Feedback through a MAC signaling header as shown in Table 10 so that the mobile station 200 can transmit channel information through a stand-alone MAC PDU packet without a data payload for composing the MAC PDU.

TABLE 10

| | Size | |
|---|---|---|
| Syntax | (bits) | Notes |
| Correlation Matrix Feedback Report | | |
| Header ( ) { | | |
| FID | 4 | Flow Identifier |
| Type | 4 | MAC signaling header |
| | | type |
| for (i = 1; i <= Nt; i++) { | | Nt: the number of |
| | | transmit antennas of the |
| | | base station |
| i-th diagonal entry of correlation | 1 | |
| matrix | | |
| for (j = i+1; j <= Nt; j++) { | | |
| (i,j)-th entry of correlation | 4 | |
| } | | |
| } | | |
| Padding | variable | For byte alignment |
| } | | |

As shown in Table 10, a correlation matrix feedback report header corresponding to a signaling header according to an embodiment of the present invention includes a flow identifier field, a type field, and a matrix correlation matrix field.

According to an MIMO feedback transmission method in the wideband wireless access system for an embodiment of the present invention, the mobile station 200 can transmit MIMO feedback information to the base station 100 through the MAC signaling header corresponding to a stand-alone MAC PDU packet without a data payload for composing the MAC PDU as described in Rules 2-7 to 2-9. Also, in a case that the base station 100 performs multiple allocations to the mobile station 200 of plural MIMO feedbacks for various types of feedback modes to request wireless channel state information required in various MIMO transmission modes, the mobile station 200 can transmit MIMO feedback information to the base station 100 by concatenating some or all of the above-described MAC control message, the above-described extended header, and the other MAC PDU combined by a data payload.

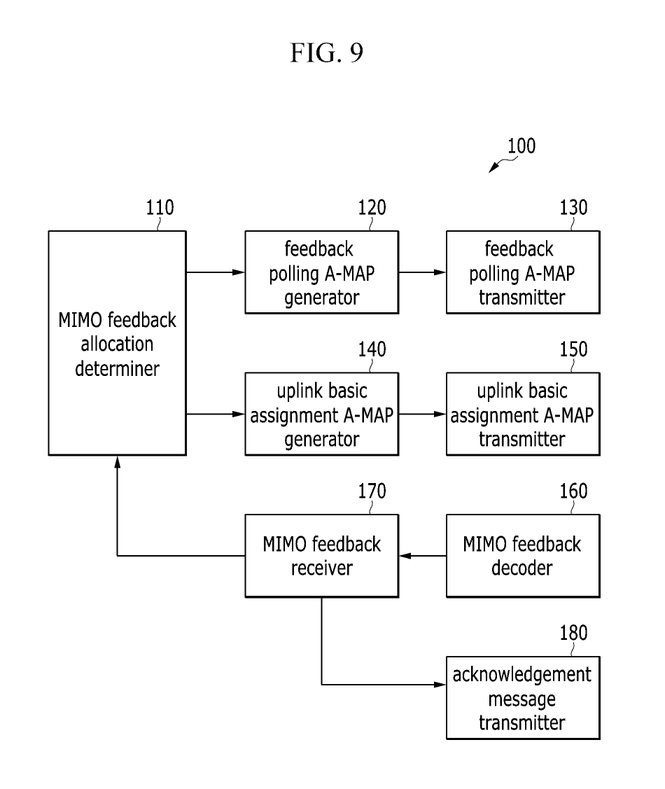

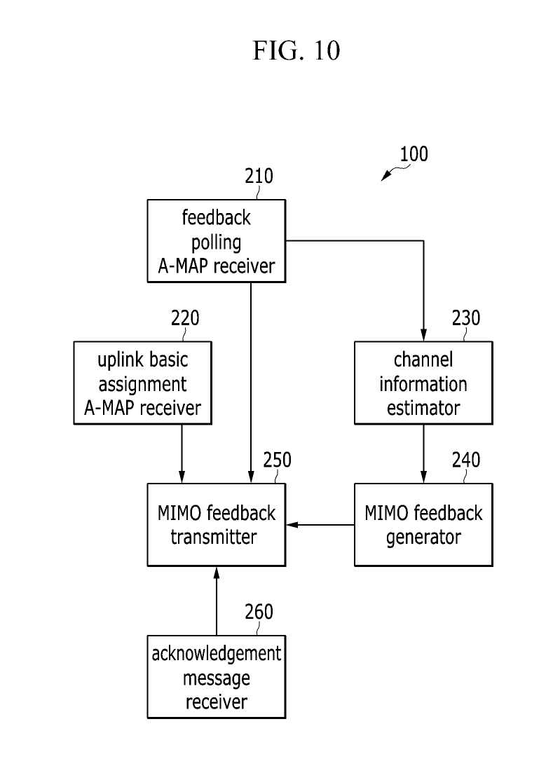

Next, a base station 100 and a mobile station 200 according to an embodiment of the present invention will be described with reference to FIG. 9 and FIG. 10.

FIG. 9 is a block diagram of a base station according to an embodiment of the present invention.

As shown in FIG. 9, a base station 100 according to an embodiment of the present invention includes a MIMO feedback allocation determiner 110, a feedback polling A-MAP generator 120, a feedback polling A-MAP transmitter 130, an uplink basic assignment A-MAP generator 140, an uplink basic assignment A-MAP transmitter 150, a MIMO feedback receiver 160, a MIMO feedback decoder 170, and an acknowledgement message transmitter 180.

The MIMO feedback allocation determiner 110 determines an HARQ channel identifier (ACID) for a MIMO feedback of a mobile station 200, a period for the MIMO feedback of the mobile station 200, a MIMO feedback mode of the mobile station 200, and an uplink resource allocated to the HARQ channel identifier (ACID).

The feedback polling A-MAP generator 120 generates at least one feedback polling A-MAP including the HARQ channel identifier (ACID) for the MIMO feedback of the mobile station 200, the period for the MIMO feedback of the mobile station 200, the MIMO feedback mode of the mobile station 200.

The feedback polling A-MAP transmitter 130 transmits the at least one feedback polling A-MAP to the mobile station 200.

The uplink basic assignment A-MAP generator 140 generates an uplink basic assignment A-MAP including information on the uplink resource allocated to the HARQ channel identifier (ACID).

The uplink basic assignment A-MAP transmitter 150 transmits the uplink basic assignment A-MAP to the mobile station 200.

The MIMO feedback receiver 160 receives a HARQ burst reporting the MIMO feedback from the mobile station. A single base station MIMO feedback message, a multi base station MIMO feedback message, a MIMO feedback extended header, a MIMO feedback report header, and a correlation matrix feedback report header may be received as the MIMO feedback.

The MIMO feedback decoder 170 decodes the HARQ burst.

The acknowledgement message transmitter 180 transmits an acknowledgement message representing whether the HARQ burst is successfully decoded or not to the mobile station 200. When a new MIMO feedback is successfully decoded prior to a previous MIMO feedback, the acknowledgement message transmitter 180 does not transmit the NACK for the previous MIMO feedback and terminates a retransmission process for the previous MIMO feedback.

FIG. 10 is a block diagram of a mobile station according to an embodiment of the present invention.

As shown in FIG. 10, a mobile station 200 according to an embodiment of the present invention includes a feedback polling A-MAP receiver 210, an uplink basic assignment A-MAP receiver 220, a channel information estimator 230, a MIMO feedback generator 240, a MIMO feedback transmitter 250, and an acknowledgement message receiver 260.

The feedback polling A-MAP receiver 210 receives a feedback polling A-MAP from a base station 200.

The uplink basic assignment A-MAP receiver 220 receives a uplink basic assignment A-MAP from the base station 200.

The channel information estimator 230 estimates channel information corresponding to an allocated MIMO feedback mode by the feedback polling A-MAP.

The MIMO feedback generator 240 may generate a single base station MIMO feedback message, a multi base station MIMO feedback message, a MIMO feedback extended header, a MIMO feedback report header, and a correlation matrix feedback report header as the MIMO feedback according to a content of the MIMO feedback.

The MIMO feedback transmitter 250 transmits an HARQ burst for reporting the MIMO feedback.

The acknowledgement message receiver 260 receives the acknowledgement message representing whether the HARQ burst is successfully decoded or not from the base station 200. When receiving a NACK, the acknowledgement message receiver 260 instructs the MIMO feedback transmitter 250 to retransmit the MIMO feedback. However, when receiving an ACK for the new MIMO feedback before receiving an ACK for a previous MIMO feedback, the acknowledgement message receiver 260 does not instruct the MIMO feedback transmitter 250 to retransmit the MIMO feedback and terminates a retransmission process for the previous MIMO feedback.

The embodiments of the present invention are not implemented only by a device and/or method, but can be implemented through a program for realizing functions corresponding to the configuration of the embodiments of the present invention and a recording medium having the program recorded thereon. These implementations can be realized by the ordinarily skilled person in the art from the description of the above-described embodiment.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method of transmitting a multi-input multi-output (MIMO) feedback by a mobile station, the method comprising:
receiving a MIMO feedback mode bitmap;
estimating channel information corresponding to at least one MIMO feedback mode indicated by the MIMO feedback mode bitmap;
generating a MIMO feedback including the MIMO feedback mode bitmap and the channel information corresponding to the at least one MIMO feedback mode indicated by the MIMO feedback mode bitmap; and
transmitting the MIMO feedback to the base station.

2. The method of claim 1, wherein the MIMO feedback mode bitmap includes:
one or more bits representing one or more MIMO feedback modes for reporting wideband channel quality information, respectively; and
one or more bits representing one or more MIMO feedback modes for reporting subband channel quality information, respectively.

3. The method of claim 2, further comprising receiving information on a MIMO feedback period,
wherein the MIMO feedback is transmitted at advent of the MIMO feedback period.

4. The method of claim 3, further comprising:
receiving information on a hybrid automatic repeat request (HARQ) channel identifier for the MIMO feedback; and
receiving information on a radio resource allocated to the HARQ channel identifier,
wherein the MIMO feedback is transmitted through the radio resource allocated to the HARQ channel identifier.

5. A method of receiving a multi-input multi-output (MIMO) feedback by a base station, the method comprising:
transmitting a MIMO feedback request including a MIMO feedback mode bitmap to the mobile station; and
receiving, from the mobile station, a MIMO feedback including the MIMO feedback mode bitmap and channel information corresponding to at least one MIMO feedback mode indicated by the MIMO feedback mode bitmap, in response to the MIMO feedback request.

6. The method of claim 5, wherein the MIMO feedback mode bitmap includes:
one or more bits representing one or more MIMO feedback modes for reporting wideband channel quality information, respectively; and
one or more bits representing one or more MIMO feedback modes for reporting subband channel quality information, respectively.

7. The method of claim 6, further comprising:
transmitting information on a hybrid automatic repeat request (HARQ) channel identifier for the MIMO feedback to the mobile station; and
transmitting information on a radio resource allocated to the HARQ channel identifier to the mobile station,
wherein the MIMO feedback request includes information on a MIMO feedback period, and
the MIMO feedback is received through the radio resource allocated to the HARQ channel identifier at advent of the MIMO feedback period.

8. A method of transmitting a multi-input multi-output (MIMO) feedback by a mobile station, the method comprising:
receiving a MIMO feedback request including information on a MIMO feedback period;
estimating channel information for MIMO;
generating a signaling header including estimated channel information; and
transmitting the signaling header to the base station at advent of the MIMO feedback period standalone or together with a MAC protocol data unit.

9. The method of claim 8, wherein the MIMO feedback request includes a first MIMO feedback mode bitmap, and
wherein estimating the channel information includes estimating channel information corresponding to at least one MIMO feedback mode indicated by the first MIMO feedback mode bitmap.

10. The method of claim 9, wherein the channel information corresponds to channel quality information.

11. The method of claim 10, wherein the signaling header further includes a second MIMO feedback mode bitmap representing the at least one MIMO feedback mode.

12. The method of claim 8, wherein the channel information corresponds to a transmit correlation matrix.

13. A method of receiving a multi-input multi-output (MIMO) feedback by a base station, the method comprising:
transmitting a MIMO feedback request including information on a MIMO feedback period to a mobile station; and
receiving, standalone or together with a MAC protocol data unit, a signaling header including channel information for MIMO from the mobile station at advent of the MIMO feedback period, in response to the MIMO feedback request.

14. The method of claim 13, wherein the MIMO feedback request includes a first MIMO feedback mode bitmap,
the channel information corresponds to information corresponding to at least one MIMO feedback mode indicated by the first MIMO feedback mode bitmap, and
the signaling header further includes a second MIMO feedback mode bitmap representing the at least one MIMO feedback mode.

15. The method of claim 14, wherein the channel information corresponds to channel quality information.

16. The method of claim 13, wherein the channel information corresponds to a transmit correlation matrix.

17. A method of transmitting a multi-input multi-output (MIMO) feedback by a mobile station, the method comprising:
receiving a MIMO feedback request including a first MIMO feedback mode bitmap;
estimating channel information corresponding to at least one MIMO feedback mode indicated by the first MIMO feedback mode bitmap;
generating a MIMO feedback header including a second MIMO feedback mode bitmap representing the at least one MIMO feedback mode and channel information corresponding to the at least one MIMO feedback mode; and
transmitting the MIMO feedback header to a base station.

18. The method of claim 17, wherein the second MIMO feedback mode bitmap includes one or more bits representing one or more MIMO feedback modes for reporting wideband channel quality information, respectively.

19. (canceled)

20. The method of claim 17, wherein the MIMO feedback request further includes information a MIMO feedback period, and
wherein the MIMO feedback header is transmitted at advent of the MIMO feedback period.

21. A method of receiving a multi-input multi-output (MIMO) feedback by a base station, the method comprising:
transmitting a MIMO feedback request including a first MIMO feedback mode bitmap to a mobile station; and
receiving, from the mobile station, a MIMO feedback header including channel information corresponding to the at least one MIMO feedback mode indicated by the first MIMO feedback mode bitmap and a second MIMO feedback mode bitmap representing the at least one MIMO feedback mode, in response to the MIMO feedback request.

22. The method of claim 21, wherein the second MIMO feedback mode bitmap includes one or more bits representing one or more MIMO feedback modes for reporting wideband channel quality information, respectively.

23-31. (canceled)
